(19) United States
(12) Patent Application Publication
(10) Pub. No.: US 2026/0290292 A1
(43) Pub. Date: Sep. 24, 2026

(54) SYSTEM

(71) Applicant: SoftBank Group Corp., Tokyo (JP)

(72) Inventor: Shuhei SUZUKI, Tokyo (JP)

(73) Assignee: SoftBank Group Corp., Tokyo (JP)

(21) Appl. No.: 19/567,084

(22) Filed: Mar. 14, 2026

(30) Foreign Application Priority Data
Mar. 19, 2025 (JP) 2025-045021

(51) Int. Cl. G10H 1/00; G06F 16/3329; G06F 40/30

(52) U.S. Cl. CPC G10H 1/0025; G06F 16/33295; G06F 40/30

(57) ABSTRACT

A system includes a processor that is configured to analyze information received from an input terminal that receives a request from a user, generate a prompt sentence for instructing a generative AI model to generate music, generate music data based on the prompt sentence by using the generative AI model, and store the generated music data in a digital format so that the user can reproduce the generated music data at any time.

### CROSS-REFERENCE TO RELATED APPLICATION

This application is based on and claims priority under 35 USC 119 from Japanese Patent Application No. 2025-045021 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional music distribution and playback systems mainly provide access to pre-produced music content and do not readily enable on-demand generation of personalized music based on natural language requests of individual users. Even where generative artificial intelligence models are separately available, there is no integrated mechanism that (i) interprets user requests received through various input terminals or existing artificial intelligence assistants, (ii) automatically generates appropriate prompts for a generative AI model, (iii) generates music data in response to such prompts, and (iv) systematically stores the generated music data in a digital format so that the user can flexibly reproduce the music at any time. Furthermore, conventional systems do not sufficiently activate music sharing platforms by enabling users to easily share AI-generated music with other users in a unified framework. Accordingly, there is a need for a system that can seamlessly process user requests, generate corresponding music using a generative AI model, store such music for later playback, and promote community engagement through sharing of the generated music.

### SUMMARY

In order to solve the above-described problems, the present invention provides a system comprising a processor, wherein the processor is configured to analyze information received from an input terminal that receives a request from a user, generate a prompt sentence for instructing a generative AI model to generate music, generate music data based on the prompt sentence by using the generative AI model, and store the generated music data in a digital format so that the user can reproduce the generated music data at any time. The processor is further configured to be compatible with an existing artificial intelligence that receives the request from the user, and to generate the music by inputting the prompt sentence to the generative AI model, thereby allowing voice assistants and other existing AI interfaces to be used as front-ends for the music generation process. In addition, the processor is configured to promote activation of a music sharing platform by enabling sharing of the generated music with other users, so that users can publicly release, browse, and play AI-generated music within a community environment, thereby enhancing user engagement and expanding the range of musical experiences.

The term “system” refers to an integrated combination of hardware and software components, including at least one processor and associated memory and interfaces, that collectively perform the processing operations described in the claims.

The term “processor” refers to one or more hardware processing units, such as a central processing unit (CPU), graphics processing unit (GPU), or dedicated accelerator, capable of executing instructions stored in memory to implement the functions described in the claims. The term “input terminal” refers to any user-operated device or interface, including but not limited to a smartphone, tablet, personal computer, smart speaker, or graphical user interface, that receives a request from a user and transmits information representing the request to the processor.

The term “user” refers to an individual person or entity that issues a request for music generation and optionally consumes or shares the generated music through the input terminal. The term “request” refers to information, typically expressed as natural language text or spoken language converted into text, that indicates a user's desire for music generation with one or more conditions such as mood, scene, or genre.

The term “analyze” refers to processing operations performed by the processor to interpret, parse, classify, or otherwise derive meaning or parameters from information received from the input terminal.

The term “prompt sentence” refers to a structured text or data string generated by the processor, which encodes instructions, conditions, or parameters for the generative AI model to generate music.

The term “generative AI model” refers to a machine learning model, such as a neural network trained for generative tasks, that receives a prompt sentence and outputs music data created in response to the prompt sentence.

The term “music data” refers to digital information representing audio content corresponding to music, including but not limited to waveform data, encoded audio files, or streaming-compatible audio formats.

The term “digital format” refers to a representation of music data as electronically storable and processable data, such as compressed or uncompressed audio file formats or streaming audio formats.

The term “store” refers to recording or saving the generated music data in a memory or storage device, such as a hard disk drive, solid state drive, flash memory, or cloud storage, so that it can be accessed and reproduced at a later time.

The term “reproduce” refers to playing back stored music data so that the user can listen to the generated music via one or more output devices, such as speakers or headphones, at a time selected by the user.

The term “existing artificial intelligence” refers to an already deployed AI-based assistant or service, such as a voice assistant or chatbot, that can receive a request from the user and communicate with the system.

The term “compatible” refers to the capability of the processor to exchange information with the existing artificial intelligence, such that a request received by the existing artificial intelligence can be used to generate, transmit, or adapt a prompt sentence for the generative AI model.

The term “music sharing platform” refers to a service or environment, implemented by one or more servers or applications, that allows users to publish, discover, and play music, including AI-generated music, via a network.

The term “sharing” refers to making generated music data, or access to such data, available to other users through the music sharing platform, including publishing, listing, or otherwise exposing the generated music to multiple users.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

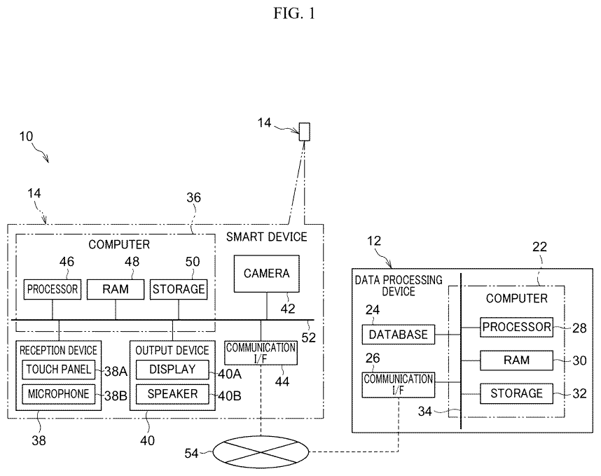

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

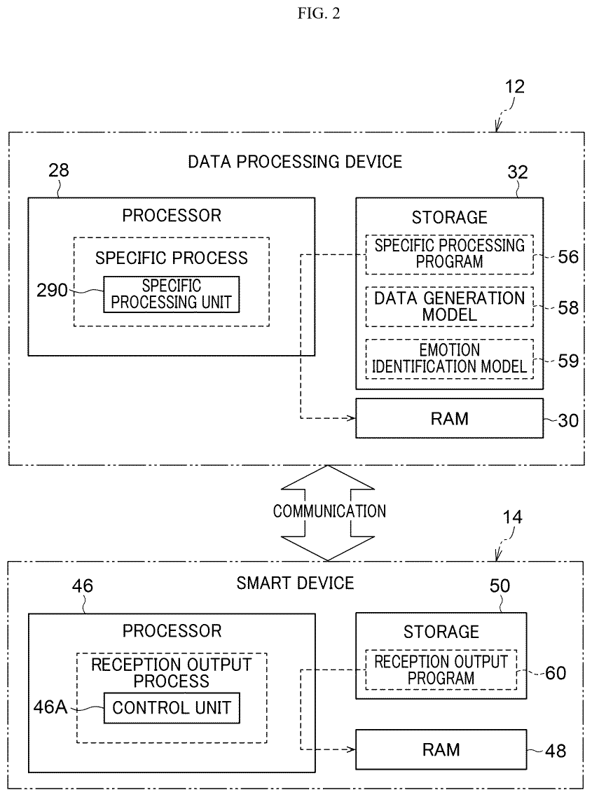

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional music delivery systems and content recommendation platforms are typically configured to select existing audio content from a catalog based on simple user preferences, such as genre or artist, and to stream the selected content to user terminals. Such systems do not natively support on-demand generation of new music content tailored to an individual user's detailed request and attribute information, such as age, gender, and fine-grained music preferences, using a generative AI model. Furthermore, when generative AI models are used in a naive manner, a number of technical issues arise in a networked computer environment.

First, conventional systems do not provide an efficient mechanism in a server to transform heterogeneous user input such as free-form natural language requests, user profile attributes, and outputs from existing information processing devices into structured model input data suitable for a generative AI model. As a result, the generative AI model may receive poorly structured or redundant data, leading to degraded output quality, increased computation overhead in the model, and inefficient use of processing resources.

Second, conventional architectures do not integrate, in a unified server-side workflow, (i) the generation of a prompt sentence and numerical feature data based on both user requests and attribute information, (ii) the invocation of a generative AI model to produce music data, (iii) the conversion of model output into an audio file encoded in a predetermined digital format, and (iv) the storage and streaming distribution of such audio files in response to subsequent playback requests. This lack of integration causes fragmentation across multiple components, redundant data transformations, and increased latency in delivering generated content to user terminals.

Third, existing systems that allow user-generated or AI-generated content sharing often manage publication, search, and recommendation functions at an application layer without tight coupling to the underlying storage and playback infrastructure. This separation makes it difficult to efficiently govern the publication range of generated audio files, to reflect user playback history or evaluation information in recommendation logic in real time, and to optimize server-side resource allocation for discovery and streaming of shared content. Fourth, many systems that interface with existing information processing devices, such as external dialog engines or legacy AI services, do not provide a robust compatibility layer at the server. In those systems, an output of an external device, even when appropriate as a prompt for a generative AI model, must be manually or heavily transformed before being usable, thereby introducing extra computational steps, additional latency, and potential inconsistencies.

Accordingly, there is a need for an improved computer-implemented system and server architecture that (1) systematically obtains and analyzes user requests and user attribute information from input terminals as structured information, (2) generates model input data including a prompt sentence and numerical feature data in a format appropriate for a generative AI model, (3) converts model output into audio files that are stored and streamed efficiently, (4) controls publication ranges and sharing of stored audio files in a manner integrated with search and playback functions, and (5) interfaces compatibly with existing information processing devices to reuse their outputs as prompt sentences. Such improvements provide a technical solution that enhances the way a server processes, generates, stores, and distributes AI-generated music over a communication network, thereby improving the overall operation and efficiency of the underlying computer system.

The specific processing by the specific processing unit 290 of the data processing device 12 in Example 1 is realized by the following means.

The present invention provides a server comprising a processor configured to obtain, from an input terminal, a request input by a user and attribute information related to the user, and to analyze the request and the attribute information as structured information; to generate, based on the analyzed request and the attribute information, model input data including a prompt sentence and numerical feature data to be input to a generative AI model for music generation, and to input the model input data to the generative AI model to cause the generative AI model to generate music data; to convert music data output from the generative AI model into an acoustic waveform, to encode the acoustic waveform as an audio file in a predetermined digital format, and to store the audio file in a storage device in association with identification information and additional information based on the request and the attribute information; to receive, from the input terminal, a playback request from the user for one of the stored audio files, to select an audio file corresponding to the playback request, and to distribute the selected audio file to the input terminal via a communication network in a streaming format such that the user can play back the audio file at any time; and to obtain, from the input terminal, a setting related to publication or sharing from the user, and to control a publication range of the stored audio file based on the setting so as to enable search and playback of the stored audio file by another user. This enables the server to perform end-to-end, computer-implemented management of AI-generated music, including structured preparation of model input data, efficient invocation of a generative AI model, standardized encoding and storage of generated audio, low-latency streaming to user terminals, and integrated control of publication and recommendation functions based on user-specific settings and behavioral information, thereby improving the technical operation and resource efficiency of the overall music generation and distribution system.

The term “system” refers to an arrangement of one or more computing devices and storage resources that cooperate via one or more communication networks to execute the processing described in the claims.

The term “server” refers to a computing device or a group of computing devices that provide processing, storage, and communication functions to one or more remote terminals over a communication network.

The term “processor” refers to one or more hardware processing units, such as a central processing unit, a graphics processing unit, or a dedicated accelerator, configured to execute instructions and perform the functions recited in the claims.

The term “input terminal” refers to an electronic apparatus operated by a user, such as a mobile communication device, a tablet device, or a personal computing device, that is capable of transmitting information to and receiving information from the server via a communication network.

The term “user” refers to an individual or an entity that operates an input terminal to issue a request, to provide attribute information, and to consume or share audio content generated by the system.

The term “request” refers to information input by a user through an input terminal, including at least one instruction or desire regarding generation or playback of music or audio content. The term “attribute information” refers to information associated with a user, including but not limited to demographic information, preference information, historical usage information, or other profile information used to customize generation or presentation of audio content. The term “structured information” refers to information represented in a defined data structure, such as a record, a list, or a key-value mapping, in which fields corresponding to a request and attribute information are normalized, categorized, or otherwise organized for processing by a program executed by the processor.

The term “model input data” refers to data prepared for input to a generative AI model, including at least a prompt sentence and one or more numerical or categorical features derived from the request and the attribute information.

The term “prompt sentence” refers to a text string that expresses, in natural language or a formalized instruction language, conditions or requirements for generating music data by a generative AI model.

The term “numerical feature data” refers to one or more numerical values or encoded representations derived from the request, the attribute information, or other related information, and formatted to be consumable as features by a generative AI model.

The term “generative AI model” refers to a machine learning model configured to generate new data, such as music data, based on input information including a prompt sentence and numerical feature data.

The term “music data” refers to digital data representing a musical content item, including but not limited to symbolic music representations, latent representations, or waveform-level representations output by a generative AI model.

The term “acoustic waveform” refers to a time-domain representation of sound pressure variations, encoded as a sequence of digital samples representing an audio signal.

The term “audio file” refers to a digital file that stores an acoustic waveform in a specified encoding format, including associated headers or metadata sufficient for playback by an audio playback device or application.

The term “predetermined digital format” refers to a specified encoding scheme for an audio file, such as a particular container format, compression codec, sampling rate, bit depth, or channel configuration, established in advance by the system.

The term “storage device” refers to a hardware resource or a logical resource configured to store digital data, including but not limited to a semiconductor memory, a magnetic storage device, an optical storage device, or a network-accessible storage service.

The term “identification information” refers to data used to uniquely or quasi-uniquely identify an audio file, a user, or a generation event, such as an identifier generated by the system or an identifier assigned in accordance with a naming scheme.

The term “additional information” refers to metadata associated with an audio file, including but not limited to information based on the request, the attribute information, timestamps, classification tags, or other descriptive information.

The term “playback request” refers to a request transmitted from an input terminal to the server, the request indicating that a specified audio file is to be streamed or otherwise delivered for reproduction on the input terminal.

The term “communication network” refers to a wired or wireless communication infrastructure that allows data to be transmitted between the server and input terminals, including but not limited to packet-switched networks and cellular networks.

The term “streaming format” refers to a mode of transmitting audio data in which segments of an audio file are delivered progressively over a communication network in a manner that enables a receiving device to start playback before reception of the entire file is completed.

The term “publication” refers to making an audio file, which has been generated and stored by the system, accessible to one or more users other than the user who initiated generation, in accordance with a setting specified by the user.

The term “sharing” refers to a form of publication in which access to a stored audio file is granted to one or more users or groups designated according to a setting provided by a user. The term “publication range” refers to a scope of users or user groups that are permitted to search for, access, or play back a stored audio file, as determined based on a publication or sharing setting.

The term “search” refers to a process in which the server receives query conditions from an input terminal and returns information about one or more stored audio files that match the query conditions and satisfy a publication range constraint.

The term “playback history information” refers to information that records past playback activities related to one or more audio files, including but not limited to identifiers of played audio files, playback times, durations, and associated user identifiers.

The term “evaluation information” refers to feedback information provided by a user or inferred by the system regarding an audio file, including but not limited to ratings, likes, dislikes, or other preference indicators.

The term “presentation order” refers to an order in which information about one or more audio files is arranged for display or listing on an input terminal.

The term “recommendation result” refers to a set of one or more audio files suggested by the server to a user based on at least playback history information, evaluation information, attribute information, or other contextual information.

The term “existing information processing device” refers to an external system or component, such as a pre-existing artificial intelligence service or dialog engine, that can generate speech or text output used as part of a request or prompt for a generative AI model.

The term “output format of the existing information processing device” refers to a data representation, such as a text format, markup format, or structured message schema, in which the existing information processing device provides its outputs.

The term “compatible format” refers to a data representation that is consistent with, or convertible without substantial loss of information from, the output format of an existing information processing device such that the output can be used as or incorporated into a prompt sentence for a generative AI model.

In the following embodiments, a server, a terminal, and a user cooperate to implement the claimed system. The embodiments are presented by way of example and are not limiting. Variations and modifications that fall within the scope of the claims are also contemplated.

### A. Overall System Configuration

The server includes at least one processor, a main memory, a non-volatile storage device, and a network interface. The processor may be a general-purpose central processing unit, a graphics processing unit, or a dedicated accelerator. The memory may be a semiconductor memory, and the storage device may be a magnetic or solid-state storage device or a network-accessible storage resource. The network interface connects the server to one or more terminals via a communication network such as a wired local network, a wireless local network, or a packet-switched wide area network.

The terminal includes a processor, a memory, a display, an input device such as a touch panel or a keyboard, an audio output device such as a speaker or a headphone interface, a local storage, and a communication interface. The terminal may be implemented as a mobile communication device, a tablet device, or a personal computing device.

The user operates the terminal to input a request and attribute information, to receive and play back audio content, and to configure publication or sharing settings. The user may be a human individual or an organization represented by a person.

### B. Software Architecture and Program Modules on the Server

The server executes an operating system and multiple software modules stored in the storage device and loaded into memory. The server executes, for example, the following functional modules as part of a program:
(1) A request reception module that receives, via the network interface, a request and attribute information transmitted from the terminal.
(2) A request analysis module that converts the received data into structured information and normalizes the values.
(3) A prompt and feature generation module that generates a prompt sentence and numerical feature data as model input data for a generative AI model.
(4) A generative AI inference module that executes the generative AI model on a computing resource, which may include a graphics processing unit, to generate music data.
(5) An audio post-processing module that converts the generated music data into an acoustic waveform and encodes the waveform into an audio file in a predetermined digital format.
(6) A storage management module that associates an audio file with identification information and additional information and stores these in the storage device.
(7) A streaming module that delivers stored audio files to a terminal in a streaming format in response to a playback request.
(8) A publication control module that applies user-specified publication or sharing settings to govern which users can discover and access each audio file.
(9) A recommendation module that uses playback history information and evaluation information to decide a presentation order or recommendation result for audio files.

The server implements these modules using general-purpose software frameworks. For example, the server may execute an application on top of a web application framework and invoke functions of audio processing libraries and numerical computation libraries. The server may execute a deep learning framework to run the generative AI model.

### C. Software Architecture and Program Modules on the Terminal

The terminal executes an operating system and a client application. The client application includes:
(1) A user interface module that displays input fields for a request and presents attribute information, lists generated tracks, and shows control buttons such as play, pause, publish, and share.
(2) A local state management module that holds a user identifier, basic attribute information, and identifiers of generated audio files.
(3) A communication module that sends structured requests to the server and receives structured responses.
(4) A media playback module that buffers and decodes streamed audio files and outputs audio to the audio device of the terminal.

The terminal uses platform-provided networking interfaces and audio playback interfaces to communicate with the server and reproduce the audio.

### D. Data Structures Used by the Server

The server stores, for example, the following data structures in its storage device:
(1) A user profile store in which the server records, for each user identifier, attribute information such as age, gender, and music preferences, and optionally additional data such as favorite genres and historical interactions.
(2) A track metadata store in which the server records, for each track identifier, the audio file location, the original request, the attribute information used for generation, timestamps, publication settings, and derived tags such as estimated genre and mood.
(3) A playback history store in which the server records, for each playback event, the user identifier, track identifier, playback timestamp, and playback duration.
(4) An evaluation store in which the server records, for each user and track, evaluation information such as a rating or a binary indicator expressing a like or dislike.

The server uses these data structures in combination to generate model input data, manage storage and streaming, and compute recommendations.

### E. Generative AI Model Architecture and Training

The server uses a generative AI model configured to generate music data from a prompt sentence and numerical feature data. The server may use, for example, a neural network that includes:
(1) An input text encoder that converts the prompt sentence into a sequence of token embeddings. The server may implement this encoder as a multi-layer transformer encoder that performs self-attention across the tokens.
(2) A condition encoder that receives numerical feature data derived from attribute information, such as normalized age, one-hot representations of gender categories, one-hot or embedding indices of music preferences, and mood tags. The server converts these features into dense vectors via fully connected layers.
(3) A fusion module that combines the output of the text encoder and the condition encoder. The server may concatenate or add these representations and process them through additional transformer layers.
(4) A sequence generator that produces a symbolic representation of music, such as a sequence of discrete tokens representing notes, chords, timing events, and instrument assignments, or a sequence of latent codes corresponding to segments of an audio spectrogram. The server may implement this generator using a decoder-only transformer that predicts the next token or latent vector conditioned on previous elements.
(5) An audio decoder that converts symbolic or latent representations into an acoustic waveform. The server may use a neural vocoder architecture, such as an autoregressive network or a convolutional generative network, to generate waveform samples at a specified sampling rate.

The server trains the generative AI model in advance using a dataset that includes pairs of music data and associated textual descriptions and attribute labels. The server defines a loss function that combines a prediction loss for symbolic tokens or latent codes and, in the case of a vocoder, a reconstruction loss between predicted and true waveforms. The server updates the weights of the network using a gradient descent-based algorithm. The server may apply data augmentation methods such as random time shifting, pitch shifting, and noise injection to improve robustness.

The server chooses a sampling temperature parameter and other decoding parameters during inference to control the diversity and coherence of generated content. The server may specify a maximum length in tokens or in seconds for the generated sequence.

### F. Generation of Model Input Data and Prompt Sentence

The server converts a free-form request and attribute information into model input data in a controlled manner that improves technical performance. For example, the server:
(1) Receives a request from the terminal in the form of a textual request and a structured attribute set.
(2) Normalizes and validates the attribute values. The server converts age to an integer, maps gender text to a standardized code, and maps preference strings to internal codes.
(3) Maps attribute codes to numerical feature vectors. The server may use embedding tables for genre codes and mood tags, and may scale age to a normalized range between a lower bound and an upper bound.
(4) Constructs a prompt sentence in a controlled format, rather than directly passing arbitrary user text. The server injects explicit constraints such as duration, tempo range, and instrumentation when those elements are absent or ambiguous in the user text. For example, the server may generate prompt sentences such as:
“Generate a 3-minute relaxing cafe background track for a 32-year-old listener who prefers jazz and acoustic music. Mood: calm and cozy. Tempo: medium-slow. Instrumentation: plano and acoustic guitar.”
“Generate relaxing jazz or acoustic music for a woman in her 30s who is relaxing in a cafe. Duration: approximately 4 minutes. Tempo: 80 to 100 BPM. Mood: warm and laid-back.”
“Generate calm plano music for studying for a 20-year-old listener who likes classical music. Duration: 30 minutes. Tempo: slow. Instrumentation: solo plano.”
“Create energetic workout music for a 25-year-old listener who prefers electronic dance music and fast tempo songs. Duration: 20 minutes. Tempo: 130 to 150 BPM. Mood: energetic and motivating.”

By standardizing the prompt sentence structure, the server reduces ambiguity and variability in input to the generative AI model, which improves convergence of the model's inference process, reduces the number of decoding iterations required to obtain a usable sequence, and thereby improves processing speed and resource efficiency.

### G. Audio Post-Processing and Storage

The server receives music data from the generative AI model. The server then:
(1) Converts symbolic or latent representations into an acoustic waveform using the audio decoder. The server ensures that the waveform has a predefined sampling rate and channel configuration.
(2) Applies amplitude normalization so that the signal uses available dynamic range without clipping. The server may apply loudness normalization to achieve a consistent target loudness.
(3) Trims or pads the waveform to a coarsely or exactly specified duration according to the parameters included in the prompt sentence. By constraining the length, the server simplifies downstream buffering and streaming scheduling.
(4) Encodes the waveform into a predetermined digital format such as a compressed audio codec with a predefined bitrate. The server may choose a codec and bitrate suitable for the available network conditions and the capabilities of typical terminals.
(5) Generates a unique identifier for the audio file and writes the encoded audio file to the storage device or to a network-attached storage resource.
(6) Stores metadata in the track metadata store, including the identifier, the prompt sentence used for generation, the attribute information or compactly encoded representation thereof, timestamps, and publication setting defaults.

By encoding and storing generated audio files with standardized parameters, the server allows the streaming module to reuse a uniform buffering strategy, which reduces complexity in the terminal and improves the predictability of resource usage.

### H. Publication Control and Recommendation

The server provides functions that control publication ranges and compute recommendations based on technical signals. The server:
(1) Obtains a publication or sharing setting from the terminal. The setting may specify that a track is private, public, or shared with a defined subset of users.
(2) Updates the track metadata store to record the publication range. The server uses an indexing strategy that groups tracks by publication state and other attributes to speed up search queries.
(3) Collects playback history information and evaluation information from terminals, and aggregates them in the playback history store and evaluation store. The server may maintain summary statistics for each track and each user, such as a count of plays, average rating, and recency scores.
(4) Executes a recommendation algorithm that uses these signals to determine a presentation order or a recommendation result. The server may implement a matrix factorization algorithm or a neural collaborative filtering model to compute affinity scores between users and tracks. The server sorts tracks in descending order of predicted affinity and returns the top results as a recommended list.
(5) Filters candidate tracks based on publication range constraints so that private tracks are never proposed to users without authorization.

This processing reduces the number of tracks that must be scanned to serve each recommendation request, thereby lowering server-side computation, disk access, and network usage. As a result, the system reduces latency in presenting recommendations and improves scalability.

### I. Technical Effects and Improvement of Computer Technology

The server improves computer technology in several ways.

First, by converting heterogeneous user input into structured model input data that includes both a controlled prompt sentence and numerical feature data, the server reduces entropy and ambiguity in the input to the generative AI model. This structuring allows the generative AI model to converge on a suitable output in fewer decoding steps. The server thereby reduces processing time on the processor and on the graphics processing unit, lowers energy consumption, and increases throughput per hardware resource.

Second, by tightly integrating analysis, model input generation, inference, audio post-processing, storage, and streaming distribution in a single server-side workflow, the server reduces unnecessary data format conversions and redundant data transfers. For example, the server avoids multiple round-trips between independent services by retaining intermediate representations in memory and passing them directly between modules. This integration improves end-to-end latency and reduces the amount of intermediate data written to persistent storage, which in turn improves memory utilization and disk utilization.

Third, by implementing a publication control module and a recommendation module that operate on stored technical signals such as playback history and evaluation information, the server optimizes the set of tracks that must be fetched and streamed. The server can, for example, pre-compute recommendation lists and cache them for groups of users with similar profiles, thereby reducing the number of on-demand recomputations. This caching and pre-computation strategy constitutes a specific improvement in the way the server manages data and reduces communication and computation load.

Fourth, by supporting compatibility with existing information processing devices, the server enables reuse of outputs from external devices as prompt sentences with minimal additional processing. The server defines conversion rules that translate the external device's output format into the controlled prompt sentence structure, including insertion of explicit technical parameters such as target duration and tempo. This compatibility layer allows the server to reduce development and integration costs and prevents duplication of complex natural language understanding logic, while still enforcing a technically advantageous standardized input structure to the generative AI model.

Fifth, the generative AI model, as implemented by the server, applies a specific neural network architecture and training regime adapted to the server's structured input format. This alignment between the server's pre-processing and the model's architecture yields lower error in generated outputs, more stable convergence during inference, and a reduced need for post-generation corrections compared to naive use of generic models. These effects represent improvements to the operation of the computer system, not merely automation of a human creative task.

### J. Alternative Embodiments and Variations

The server may employ alternative neural network architectures as the generative AI model, such as a diffusion-based model that generates spectrograms by iteratively denoising latent variables conditioned on the prompt sentence and numerical features. In such an embodiment, the server calculates a schedule of noise levels and a denoising step count adapted to the requested audio duration and desired quality level. This adaptation allows the server to trade off computation time against fidelity in a controlled manner, thereby optimizing resource usage.

The server may implement alternative encodings of attribute information, such as graph-based representations of relationships between genres and moods, and process them through a graph neural network as part of the condition encoder. This alternative further improves the precision of capturing user preference structures at the cost of additional computation. The server can dynamically select between encoders based on available compute resources, which further demonstrates a technical control over resource allocation. The server may deploy multiple versions of the generative AI model optimized for different ranges of output length or different device classes. For example, the server may select a compact model for generating short notification tones that can be streamed over low-bandwidth links, and a larger model for generating long background tracks when sufficient network capacity is detected. The server can detect network conditions and terminal capabilities and choose an appropriate model version, thereby reducing communication and computation load while maintaining acceptable quality.

The terminal may implement additional local buffering and caching logic, such as retaining the first segment of frequently played tracks in local storage, to reduce network requests and further lower latency for repeated playback. The server can instruct the terminal whether a track is suitable for such caching based on publication status and digital rights considerations. In all of these embodiments, the server, the terminal, and the user cooperate in a manner that produces AI-generated music in response to user input, but the cooperation is anchored in specific data structures, neural architectures, and processing steps that improve the functioning of the computer system itself.

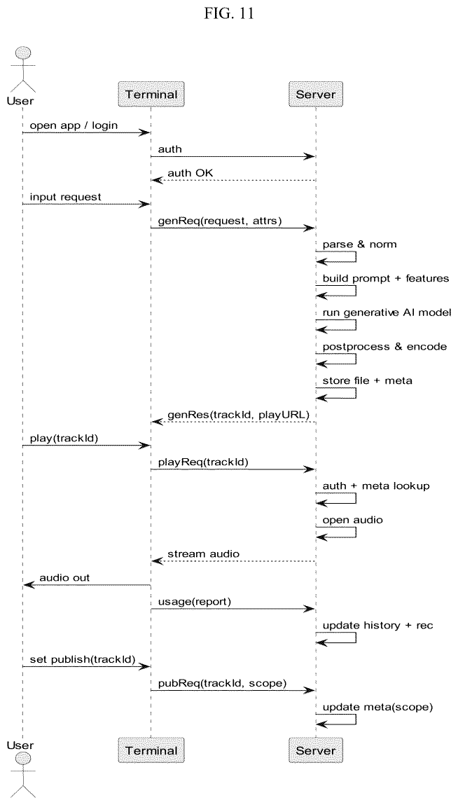

The following describes the processing flow using FIG. 11.

### Step 1

The user operates the terminal to launch a client application and authenticate.

The input to this step is user authentication information, such as a user identifier and a credential.

The terminal transmits the authentication information to the server, and the server verifies the information against a user profile store.

The output of this step is an authenticated session state associated with the user, stored both on the server side and on the terminal side.

### Step 2

The user operates the terminal to input a natural language request and to confirm or modify attribute information.

The input to this step is user keystrokes or touch inputs that specify a request, such as “Generate relaxing jazz or acoustic music for a woman in her 30s who is relaxing in a cafe,” and selections or confirmations of attribute information such as age, gender, and music preferences.

The terminal converts these inputs into text and structured fields, associates them with the current user identifier, and temporarily stores them in local memory.

The output of this step is a local data structure on the terminal that contains the request text, the attribute information, and the user identifier.

### Step 3

The terminal constructs and sends a generation request message to the server. The input to this step is the local data structure containing the request text, attribute information, and user identifier.

The terminal serializes this structure into a formatted message, such as a JSON object with keys for “request_text,” “age,” “gender,” “preferences,” and “user_id,” and transmits the message to a designated server endpoint via a communication network.

The output of this step is a network message containing the user's request and attribute information made available to the server.

### Step 4

The server receives and parses the generation request message.

The input to this step is the serialized message received via the network interface.

The server deserializes the message to reconstruct a server-side data structure that holds the request text, the attribute values, and the user identifier, and the server verifies that mandatory fields are present and correctly formatted.

The output of this step is a validated, in-memory representation of the request and attribute information associated with the authenticated user.

### Step 5

The server normalizes and enriches the attribute information.

The input to this step is the validated data structure containing raw attribute values, such as age strings, gender strings, and preference strings, and the user identifier.

The server converts age values to integers, maps gender strings to standardized categorical codes, maps preference strings such as “jazz” or “acoustic” to internal genre codes, and, if necessary, queries a user profile store using the user identifier to retrieve additional preference data.

The output of this step is an enriched attribute data structure with normalized numeric age, standardized gender codes, internal genre codes, mood tags, and any additional retrieved attributes.

### Step 6

The server generates a controlled prompt sentence and numerical feature data.

The input to this step is the original request text and the enriched attribute data structure.

The server executes an algorithm that combines the request text with attribute information, inserts explicit constraints such as duration, tempo, and instrumentation when missing, and constructs a standardized prompt sentence, for example, “Generate a 4-minute relaxing jazz/acoustic café track for a 34-year-old woman who prefers soft plano, acoustic guitar, and a calm mood. Tempo: 80 to 100 BPM.”

In parallel, the server converts attribute codes into numerical feature data by applying operations such as one-hot encoding, embedding lookups, and scaling of numeric values into predetermined ranges.

The output of this step is model input data consisting of the controlled prompt sentence and a numerical feature vector.

### Step 7

The server feeds the model input data into the generative AI model and runs inference to generate music data.

The input to this step is the controlled prompt sentence and the numerical feature vector.

The server converts the prompt sentence to a sequence of token identifiers using a tokenizer, maps the token identifiers to embedding vectors, processes the embeddings and the numerical feature vector through the layers of the generative AI model, and performs iterative decoding to obtain either a sequence of symbolic music tokens or a sequence of latent vectors representing audio content.

The output of this step is music data in a model-specific representation, such as a symbolic event sequence or a latent code sequence held in memory on the server.

### Step 8

The server converts the music data into an acoustic waveform.

The input to this step is the symbolic or latent music data generated by the generative AI model.

The server applies a decoding pipeline appropriate to the representation, for example, (i) decoding symbolic tokens to MIDI-like events and synthesizing audio via a software synthesizer, or (ii) feeding latent codes into a neural vocoder to produce waveform samples at a predetermined sampling rate.

The output of this step is a time-domain acoustic waveform represented as a sequence of digital samples in the server's memory.

### Step 9

The server post-processes and encodes the acoustic waveform into an audio file.

The input to this step is the raw acoustic waveform samples and the previously generated prompt sentence and attribute information.

The server normalizes the amplitude to avoid clipping, applies loudness normalization to match a target level, truncates or pads the waveform to meet a target duration, and then encodes the waveform into a predetermined digital format, such as a compressed audio file with specified sampling rate and bitrate.

The output of this step is an encoded audio file, for example in a compressed format, stored temporarily in the server's storage subsystem together with an associated in-memory identifier.

### Step 10

The server registers metadata and persists the audio file.

The input to this step is the encoded audio file, a newly generated track identifier, the prompt sentence, the enriched attribute data, and a default publication setting.

The server writes the encoded audio file to a storage device at a computed file path or object key, and inserts a record into a track metadata store containing the track identifier, the storage location, the prompt sentence, the attribute information used for generation, timestamps, and the publication setting.

The output of this step is a persistent association between the track identifier and the stored audio file and metadata in the server's storage and database systems.

### Step 11

The server returns a generation completion response to the terminal.

The input to this step is the track identifier, the metadata record, and optionally a generated description derived from the prompt sentence and attributes.

The server constructs a structured response message that includes at least the track identifier and a playback URL or token, and transmits this message to the terminal over the communication network.

The output of this step is a response message received by the terminal that identifies the newly generated track and provides information necessary for playback.

### Step 12

The terminal receives the generation completion response and updates the user interface.

The input to this step is the response message from the server containing the track identifier and playback information.

The terminal deserializes the message, extracts the track identifier and playback URL or token, stores them in a local list of generated tracks associated with the user, and updates the display to present the new track with a title or description and a control such as a “Play” button.

The output of this step is an updated user interface state that presents the availability of the generated track to the user.

### Step 13

The user initiates playback of a stored audio file from the terminal.

The input to this step is the user's selection of a track on the terminal interface, such as tapping the “Play” button associated with the track.

The terminal maps this action to the corresponding track identifier and playback URL or token from its local state and prepares a playback request message for the server.

The output of this step is a playback request message that references the selected track identifier and user identifier.

### Step 14

The terminal sends the playback request to the server.

The input to this step is the playback request message constructed by the terminal.

The terminal transmits the request via the communication interface to a dedicated playback endpoint of the server, including the track identifier, user identifier, and any session information needed for authorization.

The output of this step is delivery of the playback request to the server for processing.

### Step 15

The server validates the playback request and retrieves the corresponding audio file.

The input to this step is the playback request message containing the track identifier and user identifier.

The server checks authorization by verifying that the user is permitted to access the track based on the track's publication setting and the user's relationship to the track, queries the track metadata store to obtain the file location, and opens the encoded audio file from the storage device.

The output of this step is an open stream or access handle to the encoded audio file ready for streaming.

### Step 16

The server streams the encoded audio file to the terminal.

The input to this step is the open audio file handle and the playback request context, including any streaming protocol parameters.

The server reads the audio file in segments, constructs streaming responses such as HTTP chunked responses or segment files and manifest files for a streaming protocol, and transmits these segments sequentially or adaptively to the terminal.

The output of this step is a continuous stream of audio data segments arriving at the terminal.

### Step 17

The terminal buffers, decodes, and plays the streamed audio data.

The input to this step is the sequence of audio data segments transmitted from the server.

The terminal stores incoming segments in a buffer, decodes the encoded audio using a codec appropriate to the predetermined digital format, fills an audio playback buffer with decoded samples, and drives the audio hardware to output sound through speakers or headphones.

The output of this step is audible playback of the generated music for the user and an optional local record of playback events, such as play start time and duration.

### Step 18

The terminal records playback and evaluation information and sends it to the server.

The input to this step is the playback event data, such as the track identifier, user identifier, playback start and stop timestamps, and optional user evaluations such as ratings or like/dislike inputs.

The terminal constructs a usage report message containing this information and transmits it to the server over the communication network.

The output of this step is a usage report received by the server that reflects the user's interaction with the generated track.

### Step 19

The server updates playback history and evaluation stores and optionally recomputes recommendation data.

The input to this step is the usage report containing playback and evaluation information.

The server writes a new record to the playback history store and updates any existing evaluation record in the evaluation store, and then runs a recommendation update algorithm that adjusts per-user and per-track statistics and, if necessary, recalculates recommendation scores for affected users and tracks.

The output of this step is an updated set of historical data and recommendation scores stored on the server for future search and recommendation queries.

### Step 20

The user configures publication or sharing settings for a generated track via the terminal.

The input to this step is a user interaction, such as selecting a generated track and choosing a publication mode like “Private,” “Public,” or “Shared with selected users.”

The terminal converts this choice into a structured publication setting message referencing the track identifier and the desired publication range and sends it to the server.

The output of this step is a publication setting message made available to the server.

### Step 21

The server applies the publication or sharing settings to the stored audio file.

The input to this step is the publication setting message containing the track identifier and the chosen publication range.

The server updates the corresponding metadata record in the track metadata store to reflect the new publication range and adjusts indexing so that search and recommendation queries will include or exclude the track appropriately for different users.

The output of this step is a persisted publication configuration that governs how the track can be discovered and played by other users.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented music distribution systems typically retrieve pre-produced audio content from a storage device and deliver such content to user devices or in-store audio equipment. In these conventional systems, a processor merely selects from a fixed catalog of tracks using simple filtering or rule-based logic based on coarse conditions such as genre, time zone, or location. As a result, the processor does not dynamically adapt the generated or selected music to fine-grained, real-time contextual information, such as detailed user attributes, behavioral characteristics, and current customer distributions in a physical space. This limitation prevents effective optimization of the atmosphere in a store or other installation space, and does not fully exploit the computational capabilities of modern generative AI models.

Furthermore, conventional systems treat the input to a generative AI model, if used at all, as a static or manually written text description. The processor does not automatically integrate heterogeneous data sources such as user profiles, behavioral logs, and sensor-based customer analytics into a unified prompt sentence for the generative AI model. As a consequence, the generative AI model operates with incomplete context, leading to suboptimal generation results, and the underlying computer system fails to achieve improved technical performance in terms of context-aware content generation.

In addition, existing architectures typically separate the generation of music from its scheduling and real-time adaptation within the installation space. A processor may generate music once and then play it back without continuous feedback from in-store sensors or from updated user interactions. This lack of closed-loop control leads to increased manual intervention, inefficient use of computing resources, and degraded alignment between the music and the actual state of the environment and customers.

Moreover, conventional platforms for sharing generated music among multiple users generally focus on user-to-user content exchange and recommendation lists, while neglecting programmatic reuse of prior generation context, such as the prompts, attribute distributions, and environmental conditions that produced a given track. This prevents the processor from leveraging accumulated generation metadata to improve subsequent prompt construction and model conditioning, and thus does not enhance the functioning of the computer system that manages content generation and distribution.

Accordingly, there is a need for a computer system and a server-side processing mechanism that: (i) programmatically acquires and fuses user requests, user attributes, behavioral characteristics, and real-time customer distributions in an installation space; (ii) converts this fused information into structured numerical feature values and a dynamically generated natural-language prompt sentence; (iii) supplies these as inputs to a generative AI model to generate music data; and (iv) uses the resulting music data and associated management information in a feedback loop to dynamically optimize the atmosphere of the installation space and to improve the efficiency and technical performance of the content generation and distribution pipeline. Such a solution would constitute an improvement in the field of computer technology by enhancing how processors handle heterogeneous data, generate model inputs, and control real-time multimedia playback in response to changing environmental conditions.

The specific processing by the specific processing unit 290 of the data processing device 12 in Application Example 1 is realized by the following means.

The present invention provides a server comprising a processor and a storage device, the processor being configured to execute computer-readable instructions to acquire, from an input terminal, information indicating a request of a user and to analyze the acquired information to extract request contents including music generation conditions; to acquire, from the storage device, attribute information and behavioral characteristics relating to the user and to convert the attribute information and the behavioral characteristics into numerical feature values by performing statistical processing and normalization processing, thereby generating a user feature vector; to acquire detection information from a detection device disposed in an installation space, to estimate attributes of customers within the installation space based on the detection information, and to generate numerical feature values representing an attribute distribution of a customer group by aggregating the attributes of the customers, thereby generating a customer group feature vector; to generate, based on the music generation conditions, the user feature vector, and the customer group feature vector, a prompt sentence to be used as input to a generative AI model, the prompt sentence being constructed in a natural language format and representing, in a unified textual description, constraints and contextual information derived from heterogeneous data sources; to input the prompt sentence and the numerical feature values into the generative AI model and to generate music data by numerical computation processing performed by the generative AI model; to encode the generated music data into a predetermined audio data format, to store the encoded music data in the storage device, and to store, as management information associated with the music data, the prompt sentence and the attribute distribution of the customer group; to monitor, on a continuous or periodic basis, the attribute distribution of the customers and an environmental state in the installation space, and, based on a monitoring result, to select target music data for playback from the music data stored in the storage device or to generate a new prompt sentence and cause the generative AI model to generate additional music data; to distribute the selected or generated music data to an audio output device for real-time playback so as to dynamically optimize an atmosphere of the installation space in accordance with the attribute distribution of the customer group; and to distribute the music data stored in the storage device to a user terminal via a network such that the user is enabled to play back the music data at an arbitrary time. This enables an improvement in computer technology by allowing the processor to automatically integrate multi-modal contextual data into structured numerical features and a dynamically generated natural-language prompt sentence, to provide these enriched inputs to the generative AI model, and to operate a closed-loop, context-aware content generation and distribution mechanism that adaptively controls real-time multimedia playback, thereby enhancing system responsiveness, reducing manual configuration, and improving the technical performance and efficiency of the underlying computer system.

The term “processor” refers to a hardware information processing element, such as a central processing unit or an equivalent computation element, that executes computer-readable instructions to perform arithmetic operations, logical operations, control operations, and data transfer operations.

The term “storage device” refers to a hardware data holding element, such as a volatile or non-volatile memory device, that stores programs, parameters, intermediate data, generated music data, and management information in digital form.

The term “input terminal” refers to an information input apparatus, such as a general-purpose computing device or a portable communication device, that transmits user requests and related information to a server via a communication network.

The term “user” refers to an entity, such as an individual or an organization, that operates the input terminal to specify music generation conditions and to listen to music data generated by the system.

The term “request information” refers to digital data received from the input terminal that indicates a user's desired conditions for music generation, including but not limited to genre, mood, time period, usage scenario, and duration.

The term “music generation conditions” refers to parameters extracted from the request information that define target characteristics of music to be generated, such as style, tempo, instrumentation, atmosphere, and playback length.

The term “attribute information” refers to data representing characteristics of the user, such as age category, gender category, preference categories, and other profile-related information stored in association with the user.

The term “behavioral characteristics” refers to data representing usage patterns of the user, such as listening history, skip behavior, session length, and time-of-day usage tendencies, which are derived from logs of past interactions with the system.

The term “detection device” refers to a sensing apparatus, such as an imaging device, a proximity sensor, or a wireless signal receiver, that captures physical or electronic signals from an installation space and outputs detection information relating to customers or environmental conditions.

The term “installation space” refers to a physical environment, such as a commercial facility or a public area, in which customers are present and in which audio output devices are disposed for playing back music data.

The term “detection information” refers to data output by the detection device, such as image data, signal strength data, or counting data, which is used by the processor to estimate attributes of customers and environmental states in the installation space.

The term “customer” refers to an entity, such as an individual or a group, that is present in the installation space and is subject to attribute estimation based on detection information.

The term “attribute distribution of a customer group” refers to statistical information representing aggregated attributes of multiple customers present in the installation space, such as distributions over age categories, gender categories, and crowd density levels.

The term “numerical feature values” refers to numerical data, represented for example as vectors or tensors, that encode attribute information, behavioral characteristics, or attribute distributions in a form suitable for statistical processing and input to a generative AI model. The term “user feature vector” refers to a numerical representation, derived from attribute information and behavioral characteristics of the user, that encodes characteristics of the user for conditioning the generative AI model.

The term “customer group feature vector” refers to a numerical representation, derived from detection information and aggregated attributes of customers, that encodes an attribute distribution of a customer group for conditioning the generative AI model.

The term “statistical processing” refers to computational operations, such as aggregation, averaging, frequency counting, and variance calculation, that are applied to raw attribute or behavioral data to derive summarized numerical values.

The term “normalization processing” refers to computational operations, such as scaling, standardization, or encoding, that transform raw or aggregated data into numerical feature values with controlled ranges and formats suitable for machine processing.

The term “generative AI model” refers to a trained machine learning model, such as a neural network-based model, that receives a prompt sentence and numerical feature values as inputs and outputs music data by performing numerical computation.

The term “prompt sentence” refers to a text string constructed in a natural language format that describes desired characteristics of music and contextual information, and that is used as input to the generative AI model to control music generation.

The term “natural language format” refers to a representation of information as a sequence of words and symbols according to grammatical rules of a human language so that the text can be interpreted by a language-capable model.

The term “music data” refers to digital data representing audio content, including but not limited to waveform data, encoded audio files, or intermediate symbolic representations that can be converted into audible sound.

The term “audio data format” refers to a standardized digital encoding scheme for music data, such as a waveform container format or a compressed audio format, which enables storage, transmission, and playback by audio processing devices.

The term “management information” refers to metadata associated with music data, including at least the prompt sentence, the attribute distribution of the customer group at the time of generation, and other identifiers or attributes used for indexing, retrieval, and control.

The term “environmental state” refers to conditions in the installation space, such as noise level, time of day, customer density, and other measurable factors, which may be inferred from detection information or external data.

The term “audio output device” refers to a hardware apparatus, such as a loudspeaker system, an amplifier, or an equivalent audio playback unit, that converts digital audio data into audible sound within the installation space.

The term “user terminal” refers to a computing device, such as a general-purpose computer or a portable terminal, operated by the user to receive and play back music data distributed by the server via a communication network.

The term “communication network” refers to an electronic communication infrastructure, such as a wired or wireless network, through which the server, the input terminal, the user terminal, and the detection device exchange digital data.

The term “external language processing model” refers to a language-capable computational model, such as a text generation or transformation model executed on a separate system, that receives an instruction sentence and outputs a natural language sentence used as a prompt sentence.

The term “interactive information processing device” refers to a computing system that executes an interactive program, such as a dialog system, which processes user or system-supplied input and returns a responsive natural language sentence.

The term “information providing process” refers to a sequence of server-side operations that make music data and management information available to multiple users, including operations for retrieval, presentation, and sharing of such data.

The term “music sharing platform” refers to a computer-implemented environment in which multiple users can access, share, and reuse music data and related metadata generated and managed by the system.

The term “real-time playback” refers to a mode of operation in which music data is reproduced by an audio output device substantially without delay relative to its distribution decision, such that the playback can promptly reflect current attributes and environmental states.

The term “closed-loop control” refers to a control mechanism in which the processor continuously or periodically acquires updated detection information and environmental states and adjusts generation, selection, or playback of music data based on such feedback.

In one embodiment, a server implements the claimed system as a network-connected computing apparatus including at least one processor, a main memory, a non-volatile storage device, a network interface, and one or more hardware accelerators. The server executes an operating system, such as a general-purpose server operating system, and application software including a web server, an application framework, a database management system, and a machine learning framework such as a tensor computation framework. The server also cooperates with one or more terminals and detection devices via a communication network. The server uses a processor including a central processing unit and, in some embodiments, a graphics processing unit or similar accelerator. For example, the server may employ a multi-core central processing unit to perform control logic, data pre-processing, and database operations, and a graphics processing unit with tensor cores to execute deep neural network computations. The server stores program instructions and configuration data in main memory and stores persistent data, such as user profiles, music data, and management information, in a non-volatile storage device such as a solid-state drive.

The terminal operates as an input terminal and as a user terminal. The terminal can be implemented as a portable communication device or a general-purpose computing device executing a client application or a browser. The terminal provides user interfaces for inputting music generation conditions and for playing back generated music. The user operates graphical user interface elements, such as text fields, selection menus, sliders, and buttons, displayed on a display unit of the terminal. The terminal transmits user input to the server via a secure communication protocol.

The server stores user attribute information, behavioral characteristics, and music generation conditions in a database management system, such as a relational database. The server maintains data structures such as tables for users, requests, attributes, behavioral logs, generated tracks, and management information. For example, the server may store, in a user attribute table, fields such as user identifier, age category code, gender category code, preference category codes, and historical statistics. The server may store, in a behavioral log table, time-stamped records indicating track identifiers, playback durations, skip events, and time-of-day categories.

The server converts the stored user attribute information and behavioral characteristics into numerical feature values. The server uses a data processing library, such as a numerical computing library, to apply statistical processing and normalization processing. For categorical fields, the server performs an encoding process, such as one-hot encoding or embedding index assignment, so that discrete attributes are mapped to integer indices. For numerical fields, the server applies normalization using pre-computed scaling parameters, such as a mean and variance or minimum and maximum values. The server aggregates behavioral data over predefined time windows to compute average session length, skip ratio, preferred tempo range, and other statistical quantities. These operations yield a user feature vector represented as a fixed-length array or tensor.

The server acquires detection information from one or more detection devices installed in an installation space, such as a commercial facility. The detection devices may include imaging devices, proximity beacons, wireless signal receivers, or other sensors. In one example, the detection device is an imaging apparatus that captures image frames of customers in the installation space. The server receives these frames via a local network using a streaming protocol. The server then applies a computer vision model implemented using a neural network framework to the frames.

The server can implement the computer vision model as a convolutional neural network trained to detect human figures, estimate age categories, and estimate gender categories. The server processes each frame by forwarding it through multiple convolutional layers, pooling layers, and fully connected layers. The server obtains, for each detected person, a probability distribution over age categories and a probability distribution over gender categories. The server aggregates detections over a time window to count the number of customers and to compute distributions of age categories and gender categories.

The server transforms the aggregated customer data into numerical feature values that represent an attribute distribution of a customer group. For example, the server constructs a customer group feature vector containing components such as the proportion of customers in each age category, the proportion of customers in each gender category, and a normalized crowd density value. The server again uses normalization processing to ensure that all components fall within predetermined ranges. The resulting customer group feature vector is stored in memory and optionally persisted with a time stamp.

The server constructs a prompt sentence to be input to a generative AI model. The server combines the music generation conditions, the user feature vector, and the customer group feature vector. The server uses a deterministic string construction process or, in some embodiments, an auxiliary language processing model. In a deterministic approach, the server maps feature values to descriptive phrases. For example, when the customer group feature vector indicates that the majority of customers belong to a young age category and the crowd density is moderate, the server generates phrases such as “most customers are young adults” and “the atmosphere should be moderately lively.” The server inserts these phrases, together with the music generation conditions, into a template to obtain a prompt sentence.

In another embodiment, the server sends an intermediate instruction sentence to an external language processing model, which may be implemented as a transformer-based language model. The server includes structured information, such as key-value pairs indicating genre, mood, age distribution, and crowd density, in the intermediate instruction. The external model returns a natural-language sentence describing desired music characteristics. The server adopts the returned sentence as the prompt sentence. This process results in a prompt sentence that reflects both user-specific and environment-specific context.

The server may construct prompt sentences such as:
“Generate relaxing acoustic background music for a cozy cafe in the morning. Most customers are women in their twenties. The music should be calm, with soft guitar and gentle plano, suitable for quiet conversations and a warm atmosphere.”
“Generate gentle classical background music for a bookstore in the afternoon. Customers are mainly middle-aged men, and the atmosphere should encourage concentration and long stays.”
“Generate energetic pop music for a fashion store on a busy weekend afternoon. Customers are mostly teenagers and people in their twenties, and the music should feel bright, upbeat, and exciting.”
“Please generate music for a coffee shop in the late afternoon. The main customers are office workers in their thirties and forties, and the music should be mellow jazz with a relaxed but slightly upbeat feel.”

The server inputs the prompt sentence and the numerical feature values into a generative AI model that is configured to generate music data. The generative AI model may be implemented as a transformer-based sequence model, a recurrent neural network, a diffusion model, or a combination thereof. In one specific configuration, the server uses a transformer architecture that maps tokenized text and conditioning vectors to a sequence of discrete music tokens.

The server tokenizes the prompt sentence using a tokenizer associated with the generative AI model. The tokenizer converts the text into a sequence of token identifiers. The server pads or truncates the sequence to a predetermined length and forms a text input tensor. The server concatenates the user feature vector and the customer group feature vector into a conditioning vector. The server then provides both the text input tensor and the conditioning vector to the generative AI model.

Inside the generative AI model, the server performs embedding of the text tokens into continuous vectors. The server also transforms the conditioning vector through a projection layer so that it can be injected into the model. The model then applies multiple layers of self-attention and feedforward operations. The server uses, for example, multi-head attention with learned parameters for query, key, and value projections, each implemented as matrices stored in the GPU memory. During inference, the server performs autoregressive sampling: at each time step, the model outputs a probability distribution over possible next music tokens, and the server selects or samples a token according to a sampling strategy such as temperature scaling and top-k or nucleus sampling.

In other embodiments, the generative AI model outputs an intermediate representation such as a time-frequency spectrogram or a symbolic sequence of musical events. For a spectrogram-based model, the server defines a time-frequency grid and produces magnitude values for each cell. For a symbolic model, the server outputs events such as note-on, note-off, pitch, velocity, and timing offsets. The server collects the output sequence until a predetermined length is reached or an end-of-sequence token is generated.

The server converts the generated representation into audio data. If the model outputs a symbolic representation, the server uses a software synthesizer to convert the symbols into a waveform. The server selects appropriate instrument patches based on the genre or instrumentation indicated in the music generation conditions. The server computes digital audio samples at a standard sampling rate and bit depth. If the model outputs a spectrogram, the server applies an inverse transformation, such as an inverse short-time Fourier transform, or a neural vocoder. The vocoder can be implemented as a separate neural network that maps spectrogram frames to time-domain samples via convolutional and upsampling layers. The server encodes the resulting waveform into a predetermined audio data format, such as an uncompressed waveform container or a compressed audio format. The server uses an encoding library to perform compression, bit rate allocation, and container formatting. The server then stores the encoded file in the storage device and associates it with metadata including the prompt sentence, the user identifier, the attribute distribution of the customer group, timestamps, and technical parameters. This management information is stored in database records and is linked to the file location.

The server distributes the generated music data to an audio output device located in the installation space. The server streams the encoded audio data over the network using a streaming protocol. The audio output device decodes the stream and converts the digital audio to analog signals that are delivered to loudspeakers. The server may control volume levels and transitions between tracks to avoid abrupt changes. Because the server continuously or periodically updates the customer group feature vector and the environmental state, the server can select new tracks or generate new music when conditions change, thereby adjusting the playback in real time.

The server also distributes the stored music data to the terminal operated by the user. The server exposes an interface that allows the terminal to request a list of available tracks and to request playback of selected tracks. The terminal receives the audio data over the network and uses its audio subsystem to play the music to the user. Thus, the user can listen to generated music both in the installation space and remotely.

This configuration provides technical advantages beyond simple automation of human tasks. The server uses a specific data flow and data structures to integrate heterogeneous data sources into unified inputs for the generative AI model. By converting user attributes and customer distributions into numerical feature vectors and combining them with dynamically generated prompt sentences, the server improves the conditioning of the model and increases the relevance of generated music. This leads to a reduction in the need for manual curation and a decrease in the number of generation attempts required to obtain acceptable results, which in turn reduces computational load and improves throughput.

The server also improves the functioning of the underlying computer system by employing non-conventional data processing sequences. For example, instead of feeding raw sensor data or raw user textual input directly to the model, the server applies domain-specific encoding and aggregation that reduce dimensionality and noise while preserving context that is important for music generation. The server thus reduces the size of the data transmitted to the accelerators and stored in memory, which can lower memory bandwidth usage and decrease latency.

The server employs a training process for the generative AI model that further contributes to improved technical performance. In this process, the server stores training examples consisting of prompt sentences, user feature vectors, customer group feature vectors, and target music sequences. The server defines a loss function that includes a term measuring prediction error for music tokens and, in some embodiments, a regularization term encouraging consistency between music characteristics and input attributes. The server performs gradient-based optimization, updating weight matrices in the neural network using backpropagation. The server may also use data augmentation techniques, such as transposing symbolic sequences or augmenting spectrograms with noise, to improve model robustness and generalization. This training improves the accuracy of music generation conditioned on the given features and reduces the rate of mismatched generations, thereby lowering the need for re-generation.

The server applies a closed-loop control principle: the server monitors the attribute distribution and environmental state through detection devices, uses this information as feedback to adjust prompt sentences and selection of music data, and updates model inputs accordingly. This loop enables the system to respond to changes within short time frames, such as changes in crowd composition or noise levels. Because the adjustment is based on numeric feature vectors and algorithmic rules, the system can adapt faster and more consistently than manual adjustments, improving responsiveness and overall user experience. The server processes information according to specific, non-conventional rules and algorithms that differ from human reasoning. For instance, when constructing a prompt sentence, the server may enforce constraints derived from statistical correlations identified during training, such as mapping particular age distributions to tempo ranges or harmonic complexity ranges. The server applies these mappings deterministically and consistently, which ensures that the generative AI model receives input text that aligns with numeric conditioning features. This coupling reduces internal conflicts in the model and enhances generation stability.

In alternative embodiments, the server may change the architecture of the generative AI model, such as integrating an auxiliary encoder network that processes feature vectors before combining them with text embeddings, or partitioning the model into separate modules for structural generation and timbre generation. The server may also alter the sampling strategy to optimize for reduced latency or higher variability. However, in all such variations, the server maintains the core concept of converting multiple contextual signals into coherent prompt sentences and numerical feature values that jointly condition the generative AI model. The terminal may vary in form factor, communication protocol, and user interface technology, but operates consistently to convey user requests and to reproduce generated music. The detection devices may also be substituted or combined; for example, the server may use acoustic sensors to measure ambient noise and incorporate such measurements into the customer group feature vector or environmental state. The server may further incorporate transaction data, such as aggregated sales logs, as an additional modality to refine the mapping between context and music generation conditions.

By implementing these embodiments, the server improves computer technology by enhancing the way in which heterogeneous data is transformed into inputs for a generative AI model, by optimizing the internal data flow and neural network conditioning, and by controlling physical audio output devices in a closed-loop fashion that responds to real-world conditions. This results in more accurate and contextually appropriate music generation, reduced computational waste, improved data management, and efficient use of network and hardware resources.

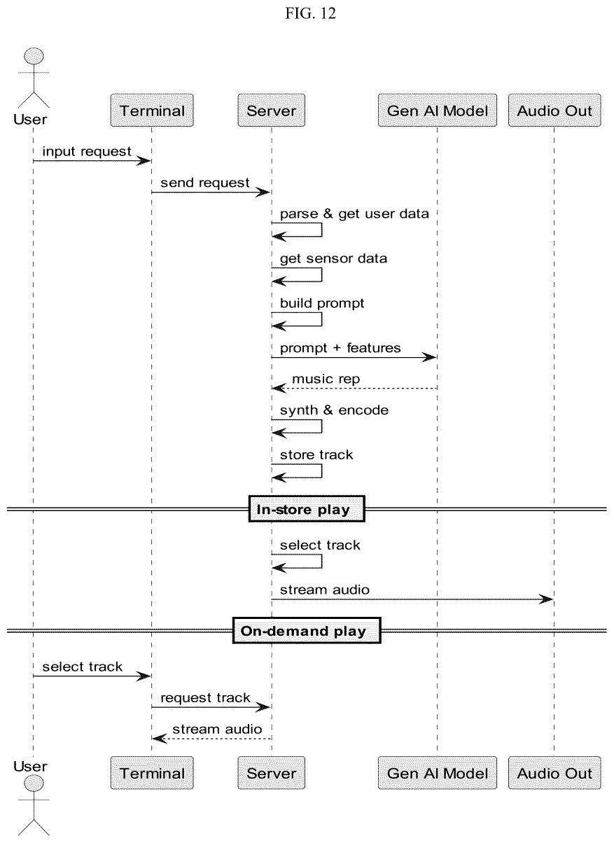

The following describes the processing flow using FIG. 12.

### Step 1

User operates the terminal to input a music generation request.

User selects or enters parameters such as store type, time period, desired mood, genre, and desired track length on a graphical user interface of the terminal. The input is captured as structured data by the terminal.

Input: User interactions on UI elements (buttons, text fields, selection lists).

Output: A structured request object including fields such as store type, time period, mood, genre, and duration.

Terminal converts the user interactions into a data structure, for example a key-value map, and serializes it into a request message appropriate for network transmission.

### Step 2

Terminal transmits the music generation request to the server.

Terminal establishes a network connection to the server and sends the serialized request object using a communication protocol.

Input: The structured request object generated in Step 1.

Output: A network message containing the request object addressed to the server.

Terminal encapsulates the request object in a protocol frame, adds header information such as destination address and authentication data, and sends the frame over a wired or wireless communication interface.

### Step 3

Server receives and parses the music generation request.

Server listens on a network interface, accepts the incoming message from the terminal, and reads the payload containing the structured request object.

Input: The network message transmitted by the terminal in Step 2.

Output: A parsed internal representation of the music generation conditions.

Server decodes the message, verifies integrity and authentication, and deserializes the payload into an internal data structure, extracting individual fields such as mood, genre, time period, and store type.

### Step 4

Server acquires user attribute information and behavioral characteristics from a storage device.

Server identifies the user based on an identifier included in the parsed request and queries data records associated with the user in a database.

Input: The internal representation of the music generation request including the user identifier.

Output: Raw user attribute records and behavioral log records.

Server executes database queries to retrieve profile entries (age category, gender category, preference labels) and historical usage logs (played tracks, durations, skip events, timestamps) and loads them into working memory.

### Step 5

Server converts user attribute information and behavioral characteristics into a user feature vector.

Server applies statistical and normalization processing to the raw attribute records and logs to produce numerical feature values.

Input: Raw user attribute records and behavioral logs obtained in Step 4.

Output: A fixed-length user feature vector represented as numerical values.

Server encodes categorical attributes using techniques such as one-hot encoding, aggregates behavioral logs to compute metrics such as average session length and skip ratio, normalizes numerical values using predefined scaling parameters, and concatenates all resulting values into a single vector structure.

### Step 6

Server acquires detection information from detection devices in the installation space. Server communicates with one or more detection devices, such as imaging sensors or wireless beacons, and obtains raw detection data describing customers and environmental conditions.

Input: Device identifiers and connection parameters stored in server configuration.

Output: Raw detection information streams or batches (for example, image frames, signal strength values, device counts).

Server initiates data acquisition by sending control commands to the detection devices, receives the returned data over the network, and buffers the data in memory for further processing.

### Step 7

Server estimates attributes of customers and generates a customer group feature vector.

Server processes the raw detection information using one or more analytical models, such as a neural network-based vision model, to infer customer attributes and aggregate them.

Input: Raw detection information obtained in Step 6.

Output: A customer group feature vector representing attribute distributions and crowd characteristics.

Server passes image data through a convolutional neural network to detect individuals and estimate age and gender categories, counts the number of individuals in each category, computes proportions for each category, estimates crowd density or noise level if available, normalizes these values, and arranges them into a fixed-length vector.

### Step 8

Server constructs a prompt sentence based on the music generation conditions, the user feature vector, and the customer group feature vector.

Server translates numerical and categorical information into descriptive phrases and assembles them into a natural-language sentence.

Input: Parsed music generation conditions from Step 3, user feature vector from Step 5, and customer group feature vector from Step 7.

Output: A prompt sentence in natural language describing the desired music and context. Server maps feature ranges to textual descriptors (for example, “young adults,” “relaxing atmosphere,” “moderate crowd”), combines them with explicit request parameters such as genre and mood, and inserts the resulting phrases into a textual template to generate a coherent prompt sentence.

### Step 9

Server optionally refines the prompt sentence using an external language processing model. Server sends an intermediate description containing structured attributes to an external text-generation service and receives a refined natural-language sentence.

Input: An initial prompt draft and structured attribute data produced in Step 8.

Output: A refined prompt sentence to be used as input to the generative AI model.

Server packages attribute values and the draft text into a request message, transmits it to the external language model, receives the response, and selects the returned sentence as the final prompt if it satisfies predefined constraints such as length and inclusion of key attributes.

### Step 10

Server tokenizes the prompt sentence and prepares model input tensors.

Server converts the prompt sentence into a sequence of token identifiers compatible with the generative AI model and arranges the user feature vector and customer group feature vector as conditioning inputs.

Input: The final prompt sentence from Step 8 or Step 9, the user feature vector from Step 5, and the customer group feature vector from Step 7.

Output: A text token tensor and conditioning tensors ready for input to the generative AI model.

Server applies a tokenizer to split the text into tokens, maps tokens to integer indices using a vocabulary, pads or truncates the sequence to a fixed length, converts it to a numeric tensor, projects or normalizes feature vectors to required dimensionality, and stores these tensors in a format suitable for processing on a hardware accelerator.

### Step 11

Server generates a music representation using the generative AI model.

Server invokes the generative AI model on a hardware accelerator, supplying the token tensor and conditioning tensors, and computes a sequence representing music.

Input: The text token tensor and conditioning tensors prepared in Step 10.

Output: A generated music representation, such as a sequence of symbolic events or a time-frequency spectrogram.

Server loads the model parameters onto the accelerator, performs forward passes through multiple neural network layers including attention and feedforward layers, iteratively samples output tokens or frames using a sampling algorithm, accumulates the outputs into a structured sequence, and stops generation upon reaching a specified length or an end-of-sequence indicator.

### Step 12

Server converts the generated music representation into audio waveform data.

Server transforms the symbolic or time-frequency representation into a sequence of digital audio samples.

Input: The generated music representation obtained in Step 11.

Output: A digital audio waveform buffer representing the generated music.

Server, when receiving symbolic events, uses a synthesis module to compute sample values for each note over time; when receiving a spectrogram, applies an inverse transformation or a vocoder network to reconstruct time-domain samples; then applies post-processing operations such as normalization, limiting, and fade-in/fade-out to generate a continuous waveform.

### Step 13

Server encodes and stores the generated music data with associated management information. Server converts the waveform into a predetermined audio file format and records metadata describing generation context.

Input: The audio waveform buffer from Step 12 and context data including the prompt sentence, user identifier, and customer group feature vector.

Output: An encoded audio file stored in a storage device and a corresponding metadata record in a database.

Server uses an encoding library to compress or package the waveform into a file, writes the file to non-volatile storage, generates a unique identifier for the track, inserts a database record containing the identifier, file location, prompt sentence, attribute distributions, timestamps, and technical parameters, and links the record to the user and installation space.

### Step 14

Server monitors the installation space and selects or triggers generation of music for playback.

Server periodically evaluates the latest customer group feature vector and environmental state to determine whether to reuse existing music data or to generate new music.

Input: Recently updated customer group feature vectors, environmental measurements, and the set of stored metadata records from Step 13.

Output: A decision indicating either a selected existing track identifier or a trigger to perform a new generation sequence.

Server computes similarity metrics between current feature values and stored generation contexts, ranks candidate tracks, selects a track that best matches current conditions, or, if no suitable track is found, initiates a new cycle from Step 8 to create additional music data.

### Step 15

Server distributes selected or newly generated music data to an audio output device for real-time playback.

Server streams the audio file corresponding to the selected track identifier to an audio output device in the installation space.

Input: The selected track identifier or reference from Step 14 and the stored audio file associated with the identifier.

Output: A continuous audio stream delivered to the audio output device and converted into audible sound.

Server reads the encoded audio file from storage, segments it into packets, sends the packets over the network using a streaming protocol, manages buffering and timing, and, if necessary, coordinates cross-fades between tracks to maintain seamless playback.

### Step 16

Server provides stored music data to the terminal for on-demand listening by the user.

Server responds to queries from the terminal requesting available tracks and streams selected tracks to the terminal for playback.

Input: Requests from the terminal specifying query conditions or specific track identifiers.

Output: Metadata lists for browsing and audio streams for playback on the terminal.

Server queries the database for tracks associated with the user or with particular attributes, formats the results as structured metadata, sends them to the terminal, and upon selection, retrieves the corresponding audio files and streams them over the network so that the terminal can decode and play them to the user.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented music generation systems that employ machine learning models often treat user input as simple, low-dimensional control values, such as a small set of presets or sliders. As a result, such systems cannot fully exploit advances in natural language understanding or generative AI models, and are unable to accept rich, free-form user requests expressed in everyday language while still providing deterministic, parameterized control over the generated music. Moreover, existing systems frequently separate natural language interfaces, such as general-purpose conversational agents, from specialized generative engines, resulting in duplicated parsing logic, inconsistent interpretation of user intent, and increased latency due to ad hoc integration layers. From a computer technology perspective, these limitations manifest as inefficient utilization of computing resources across the end-to-end pipeline: text analysis is not systematically coupled with generative conditioning, GPU-based music generation is not parameterized in a uniform intermediate representation, and storage and delivery of generated audio are often handled by loosely integrated subsystems. This fragmented architecture leads to increased processing overhead, redundant data transformations, and difficulty in scaling the system for large volumes of diverse user requests, particularly when the system must support both direct text input and voice-driven requests received via existing artificial intelligence assistants.

Furthermore, many existing platforms do not provide a unified mechanism at the processor level for converting the internal audio representation output by a generative model into standardized audio file formats that are immediately streamable or downloadable across heterogeneous terminals. The absence of a tightly specified process for generating, storing, and exposing access information for such files, and for enabling systematic sharing and aggregation of usage data through information sharing infrastructures, results in suboptimal network usage patterns, lack of observability, and limited feedback for improving model behavior and system performance.

Accordingly, there is a need for a computer-implemented system that improves the way a processor: (i) analyzes user requests using natural language processing to derive structured parameters for music generation, (ii) constructs and supplies prompt sentences and conditioning data to a generative AI model in a unified and computationally efficient manner, (iii) converts and manages generated music data in standardized audio file formats with associated access information for streaming and downloading, and (iv) interoperates with existing artificial intelligence systems and information sharing infrastructures to support voice-based input and efficient dissemination of generated content. Such a system should improve the technical functioning of the underlying computing environment by reducing integration complexity, enabling more efficient usage of processing and storage resources, and providing a consistent data flow from user intent capture to content generation, delivery, and sharing.

The specific processing by the specific processing unit 290 of the data processing device 12 in Example 2 is realized by the following means.

The present invention provides a server comprising a processor configured to receive, from a user-operated terminal, information including a request regarding generation of music; analyze the information by natural language processing to extract parameters indicating at least one of a type of music, a mood, a tempo, a length, and constituent elements of the music; generate a prompt sentence to be input to a generative AI model based on the extracted parameters; input the prompt sentence and the parameters as conditioning information to the generative AI model to generate music data; convert the music data from an internal representation corresponding to an audio signal into digital data in a standardized audio file format; store the digital data in a storage device or an external storage service; generate identification information or access information enabling streaming or downloading of the digital data in response to a request from the terminal; transmit the identification information or the access information to the terminal; receive, from the terminal, a sharing instruction; and, in response to the sharing instruction, register at least one of the stored digital data in the standardized audio file format and the access information, via a communication network, in a public area or an information sharing infrastructure so that another user can use the digital data or the access information. This enables an integrated and technically improved pipeline in which the server systematically converts natural language user requests into structured conditioning data for a generative AI model, efficiently generates and formats audio content for heterogeneous terminals, interoperates with existing artificial intelligence interfaces for voice-based input, and manages network-distributed sharing and access aggregation in a manner that reduces processing overhead, improves resource utilization, and enhances the overall performance and scalability of the computer-implemented music generation system.

The term “processor” refers to a hardware execution unit, or a combination of hardware execution units, that executes instructions to perform data processing operations, including but not limited to a central processing unit, a graphics processing unit, a digital signal processor, or any combination thereof.

The term “terminal” refers to an information processing apparatus operated by a user, including but not limited to a portable communication device, a computing device, or a display device, that is configured to transmit information to and receive information from a server via a communication network.

The term “information including a request regarding generation of music” refers to data transmitted from the terminal that expresses a user's intention concerning music generation, the data comprising at least one of natural language text, character information converted from speech, or structured control information.

The term “natural language processing” refers to a set of computational techniques executed by the processor for analyzing and interpreting human language input, including at least one of tokenization, syntactic analysis, semantic analysis, entity extraction, classification, or mapping of text to structured parameters.

The term “parameters” refers to structured data elements extracted from user-provided information, the structured data elements including at least one of a type of music, a mood, a tempo, a length, and constituent elements of the music, and being used as conditioning information for a generative AI model.

The term “type of music” refers to a category or classification of music, including but not limited to a genre, a style, or a musical form, derived from user-provided information.

The term “mood” refers to an attribute representing an emotional or atmospheric quality of music, including but not limited to energetic, relaxing, sad, or cheerful, as interpreted from user-provided information.

The term “tempo” refers to a speed attribute of music, expressible in units of time per beat or beats per minute, and derivable from qualitative or quantitative user-provided information. The term “length” refers to a time duration of music, expressible in units of time, such as seconds or minutes, and representing the intended playback duration of generated music. The term “constituent elements of the music” refers to component attributes of music, including at least one of instrumentation, rhythm pattern, harmonic structure, melodic contour, or arrangement characteristics, as determined from user-provided information. The term “prompt sentence” refers to a sequence of one or more natural language expressions generated or adapted by the processor for input to a generative AI model, the sequence encoding user intent and parameter information in textual form.

The term “generative AI model” refers to a machine learning model, implemented by software executed on one or more processors, that is configured to generate data such as music data based on conditioning information, the machine learning model including but not limited to a neural network-based model.

The term “conditioning information” refers to input data supplied to the generative AI model to control characteristics of generated output, the input data including at least one of the prompt sentence, the parameters, and derived feature representations thereof.

The term “music data” refers to digital data representing music content output by the generative AI model, the digital data including at least one of an internal audio representation, a symbolic representation, or an audio waveform representation.

The term “internal representation corresponding to an audio signal” refers to an intermediate digital representation of sound, including at least one of a time-domain sample sequence, a frequency-domain representation, a spectrogram, or a symbolic event sequence, that is usable for conversion into a standardized audio file format.

The term “standardized audio file format” refers to a digital file format for audio that conforms to a publicly known specification, including but not limited to a pulse-code modulation container format or a compressed audio format.

The term “digital data in a standardized audio file format” refers to audio data encoded and stored according to a standardized audio file format specification so as to be reproducible by general-purpose playback software or hardware.

The term “storage device” refers to a non-transitory computer-readable medium integrated with or locally accessible by the server, including but not limited to a semiconductor memory device, a magnetic storage device, or an optical storage device.

The term “external storage service” refers to a remote data storage facility accessible via a communication network, including but not limited to a remote file storage system, an object storage system, or a cloud-based storage platform.

The term “identification information” refers to data that uniquely identifies stored digital data, including but not limited to a file name, a resource identifier, a record identifier, or a combination thereof.

The term “access information” refers to data that enables retrieval or access to stored digital data, including but not limited to a network address, a resource locator, a resource identifier, or associated authentication or authorization data.

The term “streaming” refers to a mode of content delivery in which audio data is transmitted progressively from a server to a terminal such that playback can commence before the entirety of the audio data has been received or stored at the terminal.

The term “downloading” refers to a mode of content delivery in which audio data is transmitted from a server to a terminal and stored in the terminal's storage so that the audio data can be accessed or played back independently of a subsequent network connection. The term “sharing instruction” refers to a command or indication transmitted from the terminal to the server, the command or indication specifying that generated music data or associated access information should be made available to other users.

The term “public area” refers to a logical or physical region in a data management environment that is configured to allow access to content by multiple users, including but not limited to a publicly accessible data repository or a community-accessible content listing. The term “information sharing infrastructure” refers to a computer-based platform, system, or service that enables distribution, discovery, or consumption of digital content by multiple users via a communication network.

The term “existing artificial intelligence” refers to a pre-existing computing system that performs at least one of speech recognition, natural language understanding, or dialog management, and that provides character information or structured requests to the server. The term “character information” refers to digital data representing textual content, including but not limited to a sequence of characters or encoded text, obtained by converting a user's speech or input into text.

The term “voice request” refers to a user's spoken utterance that expresses a request regarding generation of music and that is captured as audio and converted into character information by an existing artificial intelligence or a speech recognition process.

The term “user operation screen” refers to a graphical user interface presented on the terminal that provides one or more interactive elements enabling a user to perform operations, including at least transmission of sharing information or confirmation of sharing actions.

The term “sharing information” refers to data that includes at least access information and optionally additional metadata, the data being suitable for transmission to an external information exchange infrastructure or a social communication service to enable access to generated music data.

The term “information exchange infrastructure” refers to a computer-based platform or service that supports transmission, reception, or routing of information among multiple users or systems, including but not limited to content distribution platforms or messaging platforms.

The term “social communication service” refers to an online service or platform that allows users to post, share, and view content, and to interact with other users through messages, comments, or similar social functions.

The term “accesses from other users” refers to events in which users other than the originating user retrieve, stream, download, or otherwise interact with generated music data via the access information.

The term “utilization of the information sharing infrastructure” refers to a degree of use or engagement with the information sharing infrastructure, measurable by at least one of a number of accesses, a number of interactions, a bandwidth usage, or a content distribution metric.

In one embodiment, a server operates as a central music generation platform that cooperates with one or more terminals operated by users. The server includes at least one processor, a main memory, a non-transitory storage device, and an interface to a communication network. The server executes an operating system such as a general-purpose server operating system and executes application software implementing natural language processing, a generative AI model for music, audio post-processing, and network communication. The terminal includes a processor, a memory, an audio output device such as a speaker or headphones, an input device such as a touch panel, keyboard, or microphone, and communication circuitry capable of establishing an encrypted connection with the server. The user operates the terminal to provide a prompt sentence describing desired music. The terminal presents a graphical user interface including a text input field and control elements such as a “Generate Music” button. The user enters a free-form natural language prompt sentence such as “Please generate energetic rock music with a fast tempo around 160 BPM,” “Create a relaxing ambient track with soft pads and gentle plano, suitable for studying,” or “Generate an upbeat pop song with a cheerful mood, female vocals, and a length of about 3 minutes.” The terminal stores the entered prompt sentence as character data in a text buffer in main memory and may display the stored text for user confirmation.

The terminal converts the prompt sentence into a structured data object that includes at least the prompt sentence and terminal-identifying information. The terminal uses a data serialization library to encode this object in a text-based data interchange format. The terminal invokes an HTTP client library to open a secure channel to the server using a transport layer security protocol. The terminal transmits the encoded prompt sentence to a predefined application programming interface endpoint of the server. By encapsulating the prompt sentence in a structured data object and transmitting it over an encrypted channel, the terminal ensures that the server receives the data in a consistent, parseable form with reduced risk of transmission errors.

The server receives the encoded prompt sentence via a network interface and passes the received data to an application server framework running in user space. The server uses a parsing library to decode the structured data and to reconstruct the prompt sentence as an in-memory character string. The server allocates a data structure, such as a record or object, to hold both the raw prompt sentence and intermediate analysis results, and stores this structure in main memory under the control of the processor.

The server applies natural language processing to the prompt sentence to extract structured parameters. In one embodiment, the server loads an NLP model implemented as a neural network comprising an embedding layer, multiple self-attention layers, and a feed-forward output layer. The server maps tokens of the prompt sentence to numerical feature vectors using an embedding matrix stored in memory, and the server processes the feature vectors through stacked self-attention blocks that compute weighted combinations of token features based on learned attention weights. The server outputs contextual embeddings and passes them to a classification head that assigns probabilities to candidate values for attributes such as music type, mood, tempo range, length category, and instrument categories.

The server converts the probabilities produced by the NLP model into deterministic parameters by selecting, for each attribute, a value that satisfies a predetermined threshold criterion or by resolving ambiguities using rule-based post-processing. For example, if tokens “rock,” “fast tempo,” and “energetic” appear in the prompt sentence, the server assigns a music type parameter corresponding to a rock category, sets a mood parameter corresponding to an energetic category, and maps “fast tempo” to a numeric beats-per-minute value such as 160 based on a predefined lookup table. The server similarly maps “relaxing ambient track with soft pads and gentle plano” to a music type parameter corresponding to ambient music, a mood parameter corresponding to relaxing, an instrumentation parameter including pad-like synthesized timbres and plano, and a tempo parameter within a lower range suitable for background listening.

The server generates a prompt sentence for a generative AI model based on the extracted parameters and the original user-provided text. In one embodiment, the server constructs a normalized textual description that encodes the parameter values in a canonical format, such as “Genre: rock; Mood: energetic; Tempo: 160 bpm; Instruments: electric guitar, drums, bass; Length: 180 seconds.” The server concatenates or combines this normalized description with the original user text to form a final prompt sentence optimized for conditioning of the generative AI model. By standardizing the representation of musical attributes in this way, the server reduces variability in conditioning data and improves reproducibility of the model's responses for similar user intents.

The server supplies the prompt sentence and the structured parameters as conditioning information to a generative AI model for music. In one embodiment, the server implements the generative AI model as a neural network with an encoder-decoder architecture. The encoder receives the prompt sentence as a sequence of embedded tokens and produces a latent representation capturing high-level semantic features of the requested music. The decoder receives the latent representation together with numeric parameter vectors representing tempo, length, and instrumentation, and generates a time-ordered sequence of audio features or musical events. The neural network may be trained using supervised learning on a corpus of audio or symbolic music paired with textual descriptions. During training, the server computes a loss function, such as a mean-squared error between predicted and target audio features or a categorical cross-entropy over event tokens, and updates the network weights via gradient descent. The server may employ regularization and data augmentation, such as time-stretching or pitch-shifting of audio, to improve generalization. The server executes the generative AI model on a graphics processing unit to accelerate matrix multiplications and convolution operations internal to the neural network. The server transfers the network weights and the conditioning feature vectors from main memory to GPU memory, and invokes a model execution framework to perform the forward propagation. The server obtains, as an output of the model, either an internal representation corresponding to an audio signal, such as a spectrogram or time-domain waveform, or a symbolic representation such as a sequence of note events with pitches, durations, and velocities. By executing the generative AI model on specialized hardware and by providing a compact, structured conditioning vector derived from natural language analysis, the server reduces the number of iterations and data transformations required to reach a target audio specification, which leads to faster generation and lower processor load compared with naive text-to-audio generation pipelines.

When the generative AI model outputs a symbolic sequence, the server converts this sequence into an internal audio representation using a synthesis module. The server selects an instrument mapping based on the instrumentation parameter; for example, for a rock genre, the server maps lead melody lines to an electric guitar timbre and rhythm patterns to a drum timbre. The server generates audio samples by passing symbolic events through a digital sound synthesis algorithm or a sampling engine, computing continuous waveform segments and concatenating them according to timing and envelope parameters. The server may apply a sample rate conversion and mixing step to ensure all instrument layers share a consistent sample rate and bit depth suitable for downstream encoding.

The server applies digital signal processing to the internal audio representation to produce final audio suitable for playback. The server may perform normalization to control overall loudness, dynamic range compression to manage volume variations, equalization to adjust spectral balance, and fade-in or fade-out processing at track boundaries. The server executes these operations using numerical algorithms implemented in an audio processing library. The server maintains the audio buffer in a contiguous memory region to reduce cache misses and to permit vectorized processing, thereby reducing latency and improving throughput when handling multiple concurrent generation requests.

The server encodes the processed audio into a standardized audio file format. The server creates a container structure that includes header information describing sample rate, bit depth, channel count, and compression parameters. The server then writes encoded audio frames into the container using a codec implementation. The server stores the resulting digital data as a file on a storage device or transmits the data to an external storage service over the network, where it is stored as an object with a unique identifier. The server records metadata, including the file identifier, the user identifier, the extracted parameters, and a timestamp, in a database to track generated content.

The server generates access information enabling streaming or downloading of the encoded audio. The server constructs a network resource locator that references the stored file and may embed authentication tokens or expiration parameters. The server transmits the access information back to the terminal within a response structure. The server may select, based on system policies or user preferences, whether to provide streaming-optimized endpoints, download-optimized endpoints, or both. The server can also generate multiple versions of the audio with different bit rates or formats and associate corresponding access information with each version to optimize bandwidth consumption for heterogeneous terminals.

The terminal receives the access information from the server and configures a media playback component. The terminal instantiates an audio player that reads audio data from the server using the provided network resource locator. When streaming, the terminal requests segments of the file sequentially, buffering them in memory. The terminal decodes the audio frames and sends them to a digital-to-analog converter that drives physical speakers or headphones. The terminal may adapt the buffer size and request pattern in accordance with network conditions, thereby contributing to a reduction in stalling events and improving the user experience. Because the audio file format is standardized, the terminal can use a single decoder implementation for content generated by different models and under different conditions.

The user listens to the generated music through the terminal and can decide to share the content. The terminal provides a user operation screen that includes a “Share” control element. When the user activates the share function, the terminal retrieves the access information, such as the network resource locator, and prepares sharing information that may include descriptive text, track title, and thumbnail image. The terminal then transmits the sharing information to an external information exchange infrastructure or a social communication service. The server may monitor usage of access information by recording access logs whenever other users click or request content via the shared link. By aggregating access events, the server can derive usage patterns that can be used to optimize caching strategies, adjust resource allocation to heavily accessed tracks, or guide future model training.

In another embodiment, the user supplies a request via an existing artificial intelligence system such as a voice assistant. The terminal or an auxiliary device captures the user's voice through a microphone and transmits the audio to a speech recognition engine. The speech recognition engine converts the voice request into character information, for example “Create relaxing music for studying.” The existing artificial intelligence system forwards this character information to the server as the user's request. The server processes this character information using the same natural language processing and parameter extraction pipeline described above. By using existing artificial intelligence only as a front-end for converting speech to text and by performing consistent parameter extraction and conditioning on the server, the system avoids duplicated logic and ensures that both typed and spoken requests traverse the same deterministic, optimized path.

From a technical viewpoint, the described architecture yields improvements beyond a mere automation of human tasks. The server introduces a specific data flow in which the prompt sentence and derived parameters are represented as structured conditioning information that is aligned with the architecture of the generative AI model. The server uses learned attention and embedding mechanisms to map natural language into parameter vectors that are directly consumed by the decoder network, eliminating intermediate ad hoc scripting that would otherwise be required to interpret user instructions. This alignment reduces redundant parsing and conversion operations, resulting in fewer memory allocations and decreased runtime per request.

The server further improves computational efficiency by segregating the tasks of natural language processing, music generation, and audio encoding into modular components with well-defined data structures. For instance, the server stores the intermediate internal audio representation in a constrained, model-specific format (such as a fixed-size spectrogram tensor) optimized for GPU memory access and DSP operations. This design allows the server to reuse the same post-processing pipeline for multiple models or variations, which reduces complexity and maintenance overhead and enables more effective caching of intermediate results in memory.

The system also enhances technical performance by allowing the server to adapt encoding parameters and streaming formats based on extracted music parameters and historical usage patterns. For example, when the server identifies that a generated track is short and highly accessed, the server may precompute multiple bit-rate versions and place them in a content delivery cache, thereby reducing latency and network congestion. In contrast, less frequently accessed or longer tracks may be encoded on demand or stored in lower bit-rate formats to conserve storage and bandwidth. This resource-aware management is grounded in the structured data recorded at generation time and in the unified representation of prompt sentences and parameters.

The generative AI model itself operates according to rules and procedures that differ from conventional human composition. The model employs high-dimensional feature spaces, attention matrices, and gradient-based learning to capture complex relationships between textual descriptions and musical structures that would be difficult for a human to define as explicit rules. For example, the model may learn to map certain combinations of adjectives and genre terms to specific rhythmic motifs or harmonic progressions by minimizing a loss function over millions of training examples. Through the use of backpropagation and weight updates, the server optimizes the model parameters in a way that systematically reduces prediction error in internal representations, thereby improving the fidelity and stylistic consistency of generated music without requiring manual rule tuning.

In additional variants, the server may employ alternative network architectures, such as diffusion-based generative models or auto-regressive sequence models, to generate audio. In a diffusion-based configuration, the server begins from a noise tensor and iteratively refines it into an audio spectrogram, guided by conditioning vectors derived from the prompt sentence and parameters. The server uses a denoising objective function during training and a schedule of variance parameters during inference, leading to stable generation with controllable attributes. In an auto-regressive configuration, the server generates audio tokens one at a time using a probability distribution conditioned on previous tokens and the prompt sentence embedding, which allows fine-grained control over temporal structure but requires specialized caching strategies to maintain throughput.

The system may also include mechanisms for dynamic adaptation. The server can update parts of the NLP model or generative AI model using new data derived from usage logs and user feedback, applying incremental learning techniques while maintaining backward compatibility. The server may adjust the pre-processing rules, such as mapping from natural language phrases to parameter ranges, based on aggregate statistics of successful generations and listening behavior. These adaptations occur within the computing environment and contribute to an ongoing improvement of the accuracy, efficiency, and responsiveness of the system.

By integrating these components into a unified server-terminal architecture, the system provides concrete improvements in computer technology. The server reduces processing overhead by unifying natural language interpretation and generative conditioning, increases throughput and scalability by exploiting specialized hardware and optimized data structures, and improves data management by systematically generating and handling standardized audio file formats and corresponding access information. The terminal benefits from consistent, format-standardized outputs that minimize the need for device-specific decoders, thereby simplifying client-side implementation. The coordinated design of the models, data structures, and network interfaces results in measurable technical effects, including shorter end-to-end latency, reduced error in parameter interpretation, more efficient use of storage and bandwidth, and more predictable performance when handling variable user demands for music generation.

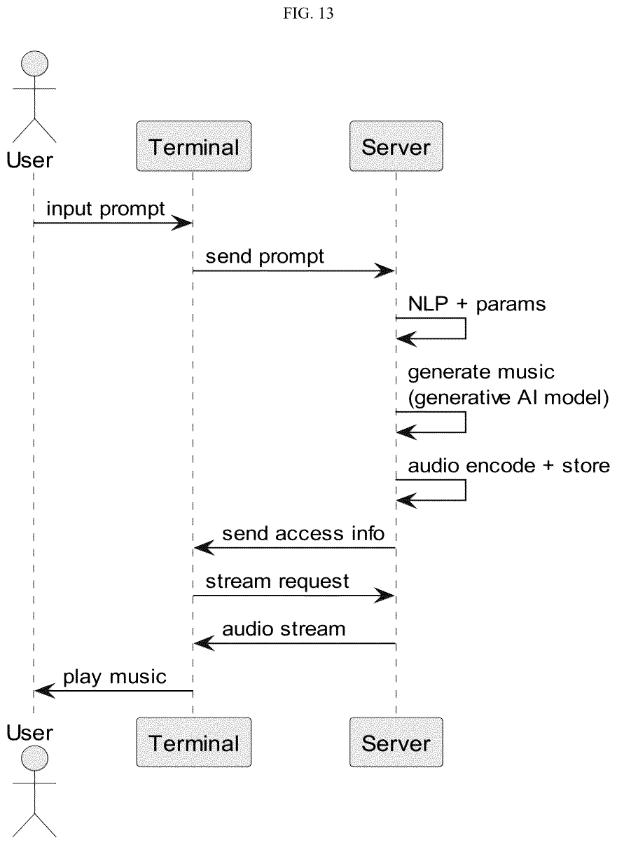

The following describes the processing flow using FIG. 13.

### Step 1

The user operates the terminal to input a prompt sentence.

The user views a graphical user interface on the terminal and selects a text input field labeled for music generation.

The user types a natural language prompt sentence such as “Please generate energetic rock music with a fast tempo around 160 BPM” or “Create a relaxing ambient track with soft pads and gentle plano, suitable for studying.”

The input of this step is a sequence of characters entered by the user via a keyboard, touch panel, or speech-to-text interface on the terminal.

The terminal converts physical input events (key presses or touch events) into character codes, accumulates the character codes in a text buffer in memory, and displays the accumulated text on the screen so that the user can confirm it.

The output of this step is a completed prompt sentence stored as a text string in the terminal's memory.

### Step 2

The terminal validates and packages the prompt sentence.

The terminal receives the prompt sentence from the text buffer and checks that the text string is non-empty and within an allowable length limit.

The input of this step is the raw text string representing the prompt sentence and terminal-specific information such as a user identifier or session identifier.

The terminal removes leading and trailing whitespace, normalizes line endings, and, if necessary, converts the character encoding to a unified internal encoding such as UTF-8.

The terminal creates a structured data object including at least the prompt sentence and optional metadata (for example, language code or preferred output format).

The terminal serializes this structured data object into a text-based interchange representation using a serialization routine.

The output of this step is a serialized data string containing the prompt sentence and associated metadata, ready for network transmission.

### Step 3

The terminal transmits the packaged prompt sentence to the server.

The terminal checks network connectivity status and selects an available communication interface such as a wireless local area network interface or a mobile communication interface. The input of this step is the serialized data string generated in Step 2 and a network address of the server.

The terminal invokes an HTTP client library to establish a secure connection to the server by performing a transport layer security handshake with the server's network endpoint.

The terminal embeds the serialized data string into the body of an HTTP request message and sets header fields such as content type and authentication token.

The terminal sends the HTTP request over the established secure channel and begins to wait for a response from the server.

The output of this step is an HTTP request containing the prompt sentence and metadata reaching the server's network interface.

### Step 4

The server receives and parses the prompt sentence data.

The server listens for incoming network connections on a designated port and accepts the terminal's secure connection.

The input of this step is the HTTP request carrying the serialized data received over the communication network.

The server terminates the secure session at a network stack layer, extracts the HTTP headers and body, and retrieves the serialized data string from the body.

The server invokes a parsing routine to deserialize the string into an internal data structure, extracting fields such as the prompt sentence, the user identifier, and optional parameters. The server allocates memory for a request object and stores the extracted values in the corresponding fields of the object.

The output of this step is a request object in server memory that contains the prompt sentence as a text string and associated metadata as structured data.

### Step 5

The server performs natural language processing on the prompt sentence to extract parameters.

The server reads the prompt sentence string from the request object and passes it to a natural language processing module loaded in memory.

The input of this step is the text string representing the prompt sentence.

The server tokenizes the sentence into word units, maps each token to a numerical embedding vector using a learned embedding matrix, and processes the sequence of vectors through multiple attention and feed-forward layers of an NLP model.

The server computes attention weights to capture dependencies between tokens and generates contextualized embeddings.

The server feeds these embeddings into one or more classification and regression heads that output probability distributions and numerical estimates for attributes such as music type, mood, tempo range, length, and instrumentation categories.

The server applies thresholding and rule-based mappings to convert the probabilities and estimates into specific parameter values (for example, genre=rock, mood=energetic, tempo=160 bpm, length=180 seconds, instruments=electric guitar, drums, bass).

The output of this step is a parameter set stored in a structured format, such as a dictionary or record, associated with the original prompt sentence in server memory.

### Step 6

The server constructs a normalized prompt sentence and conditioning information for the generative AI model.

The server takes the extracted parameter set and the original prompt sentence from memory. The input of this step is the parameter set (for example, genre, mood, tempo, length, instruments) and the original text of the prompt sentence.

The server generates a canonical description string that encodes the parameters in a fixed pattern, such as “Genre: rock; Mood: energetic; Tempo: 160 bpm; Length: 180 seconds; Instruments: electric guitar, drums, bass.”

The server concatenates this canonical description with the original prompt sentence using a defined template, thereby forming a final prompt sentence optimized for model conditioning. The server also converts selected parameters into numeric feature vectors, normalizing values such as tempo and length to fixed ranges and one-hot encoding categorical attributes such as genre and mood.

The output of this step is a final prompt sentence for the generative AI model and a set of numeric conditioning vectors stored in memory.

### Step 7

The server generates music data using the generative AI model.

The server loads a generative AI model for music into memory and transfers its parameters and relevant tensors to a hardware accelerator such as a graphics processing unit.

The input of this step is the final prompt sentence and the conditioning vectors produced in Step 6.

The server encodes the final prompt sentence into token embeddings using a text encoder module, and merges these embeddings with the numeric conditioning vectors to create a composite conditioning representation.

The server feeds this composite representation into the generative AI model's decoder or generator network and executes a forward pass on the hardware accelerator.

The server computes intermediate activations at each layer, propagates them through the network, and obtains as an output either a symbolic music sequence or an internal audio representation such as a time-domain waveform or a spectrogram tensor.

The output of this step is generated music data in an internal representation stored in server memory or in accelerator memory temporarily.

### Step 8

The server converts the internal music representation into a standardized audio file format.

The server retrieves the internal representation from memory or from the hardware accelerator and hands it to an audio post-processing module.

The input of this step is the internal music representation, which may be a symbolic sequence or a waveform or spectrogram tensor.

If the representation is symbolic, the server uses a synthesis routine to compute audio samples for each event, applying instrument mappings and timing to produce a continuous waveform.

If the representation is already a waveform or spectrogram, the server performs any necessary inversion or reconstruction to obtain a time-domain audio signal.

The server applies digital signal processing operations such as normalization, dynamic range control, equalization, and fade-in/fade-out, calculating new sample values based on the existing waveform to improve audio quality.

The server feeds the processed audio samples into an encoder that packs them into a standardized audio file format by writing header information and compressed or uncompressed audio frames into a file buffer.

The output of this step is digital audio data in a standardized audio file format stored in a file buffer in server memory.

### Step 9

The server stores the audio file and generates access information.

The server selects a storage destination such as a local storage device or an external storage service accessible over the network.

The input of this step is the audio file buffer produced in Step 8 and metadata such as user identifier and parameters.

The server writes the audio file buffer to the chosen storage location, generating a unique identifier or path for the stored file.

The server records metadata including the file identifier, the user identifier, the extracted parameters, and generation time in a database entry, performing insert operations that map symbolic identifiers to physical storage locations.

The server constructs access information such as a network resource locator or a streaming endpoint that references the stored file and, if required, includes authorization tokens or validity durations.

The output of this step is stored digital audio in the storage system and corresponding access information stored in server memory.

### Step 10

The server transmits access information to the terminal.

The server retrieves the access information from memory and associates it with the current request context.

The input of this step is the access information generated in Step 9 and the network connection established with the terminal in Step 3.

The server creates a response structure that includes at least one streaming address and optionally a download address, and encodes this structure into a transmittable format.

The server attaches appropriate response headers and sends the encoded response to the terminal over the secure communication channel.

The server may close the connection or keep it alive according to protocol rules once the transmission completes.

The output of this step is a response message received by the terminal that contains the access information needed to obtain and play the generated music.

### Step 11

The terminal receives the access information and plays or downloads the generated music.

The terminal reads the response message from its network stack and parses the content to recover the access information.

The input of this step is the response message containing streaming and/or download addresses.

The terminal configures a media player component, sets the playback source to the streaming address, and initiates streaming when instructed by the user, requesting segments of the audio file as needed.

The terminal decodes incoming audio frames, fills an audio buffer, and transfers samples to an audio output subsystem that converts the digital data to analog signals for speakers or headphones.

If the user selects a download function, the terminal requests the full file from the download address, receives the data stream, and writes the data into a persistent storage location on the terminal.

The output of this step is playback of the generated music through the terminal's audio output device and, in the case of download, a local copy of the audio file stored on the terminal.

### Step 12

The user shares the generated music through an external information sharing infrastructure. The user views a user operation screen on the terminal that includes a share control, and selects the share control after listening to the generated music.

The input of this step is the access information present on the terminal and a user command indicating a sharing intention.

The terminal constructs sharing information by combining the access information with optional descriptive text, such as a track title or comment entered by the user.

The terminal sends this sharing information to an external information exchange infrastructure or social communication service via the terminal's network interface.

The terminal may display a confirmation that sharing has completed successfully.

The output of this step is the registration of a reference to the generated music on an external platform, enabling other users to access the content by using the shared access information.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented music distribution and recommendation systems primarily rely on static metadata, such as predefined genres, playlists, and historical user preferences, to select and deliver audio content to users. These systems typically retrieve audio files from storage based on fixed rules or collaborative filtering algorithms and stream the selected content to user devices over a communication network. As a result, the generated or selected music is only indirectly related to the user's current context and is not dynamically adapted to fine-grained, real-time changes in the user's state.

With the advancement of machine learning, generative AI models have been proposed to automatically generate music based on text prompts. However, existing integrations of generative AI models in content systems often operate in a one-shot manner: a user enters a free-form request, a simple text prompt is passed to the generative model, a single music track is generated, and the system then treats the generated track as static media. In such arrangements, the server-side processing pipeline does not systematically incorporate heterogeneous user signals such as attribute information, detailed behavior history, and real-time emotion state into the construction of the prompt sentence. Moreover, the server does not provide a structured feedback loop in which distribution results, user reactions, and community interactions are fed back as behavior history to improve subsequent prompt generation and music generation. Consequently, the technical utilization of computation and storage resources on the server remains suboptimal, and the capacity of generative AI models is not fully exploited.

In addition, existing systems generally lack a robust, computer-centric mechanism to adapt music generation and streaming in real time based on the user's changing emotion state. Even when emotion recognition is available, it is often used merely for analytics or coarse recommendation. The processing architecture does not tightly couple emotion recognition results with the prompt generation pipeline and the control of the generative AI model in a way that causes the generated music data to be continuously updated and seamlessly crossfaded at the terminal. This leads to latency, discontinuities in playback, and an inability of the system to maintain a coherent, emotion-following music experience while preserving efficient use of processing and network resources.

Furthermore, in many content sharing platforms, the functions for generation, storage, distribution, and community sharing of generated content are implemented in separate subsystems with weak integration. Generated music is often exported and manually uploaded to third-party services, and server-side logic does not manage public identification information or reference information in a unified manner. As a result, it is difficult for the server to track usage, propagate shareable identifiers, and use community-level interaction data as structured input to subsequent computational processes, reducing the system's ability to evolve and optimize over time.

Accordingly, there is a need for an improved computer-implemented system, and specifically for an improved server-side processing architecture and control methodology, that (i) systematically generates a detailed prompt sentence for a generative AI model by integrating user request information, attribute information, behavior history information, and emotion state information, (ii) dynamically updates the prompt sentence and the generated music data in real time in response to changes in the emotion state, thereby achieving seamless, emotion-following streaming playback at the terminal, and (iii) manages publication and sharing of generated music with public identification information or reference information, while feeding back distribution and evaluation results as behavior history to further refine computer-controlled prompt generation and music generation. Such a system would improve the functioning of the server as a data processing apparatus, including its management of heterogeneous input signals, its real-time control of generative AI model inference, and its orchestration of storage, streaming, and sharing operations, beyond merely executing a mathematical algorithm or abstract idea.

The specific processing by the specific processing unit 290 of the data processing device 12 in Application Example 2 is realized by the following means.

The present invention provides a server comprising a processor configured to acquire user request information and attribute information transmitted from an information processing terminal, analyze the user request information and the attribute information to generate a prompt sentence that instructs a generative AI model to generate music data, augment the prompt sentence with at least one feature based on behavior history information and emotion state information of the user, and input a resulting detailed prompt sentence into the generative AI model to cause the generative AI model to generate the music data; a storage subsystem controlled by the processor and configured to store the generated music data in a digital format in association with user identification information, generation time information, the prompt sentence, and the emotion state information; a communication interface controlled by the processor and configured to receive playback requests from the information processing terminal and to stream the stored music data to the information processing terminal so that the user can play back the music data at arbitrary times; an emotion analysis module implemented by the processor and configured to acquire image information and audio information from the information processing terminal, estimate the emotion state information of the user based on the image information and the audio information using an internal or external emotion recognition process, and reflect the estimated emotion state information as a generation condition of at least one of the prompt sentence and the music data; a dynamic control module implemented by the processor and configured to sequentially generate a new prompt sentence in accordance with a change of the estimated emotion state information, input the new prompt sentence into the generative AI model to dynamically generate updated music data, and control streaming such that the information processing terminal continuously switches or crossfades between music data segments during playback to realize real-time music playback that follows the emotion state information; and a publication management module implemented by the processor and configured to acquire publication instruction information for the music data from the information processing terminal, register the music data in a distribution service or a sharing infrastructure accessible by other users, generate public identification information or reference information corresponding to the music data, distribute the public identification information or the reference information to another information processing terminal used by another user, and in response to access from the another information processing terminal provide the music data via streaming while feeding back distribution results and evaluation results of the music data as behavior history information to a subsequent prompt-generation process. This enables the server to improve computer functionality by orchestrating heterogeneous input signals, real-time generative AI model control, and integrated storage, streaming, and sharing operations in a unified architecture, thereby providing dynamically emotion-adaptive, personalized music generation and distribution that efficiently utilizes computing and network resources and that continuously refines prompt sentences and generated content based on user behavior and community interactions.

The term “system” refers to a combination of at least one server apparatus and at least one information processing terminal apparatus that cooperate via a communication network to execute the functions described herein.

The term “server” refers to an information processing apparatus including at least one processor, a storage subsystem, and a communication interface, the server being configured to execute programs to perform analysis, control, generation, storage, and distribution of data including music data.

The term “processor” refers to a hardware computation unit or a collection of hardware computation units, such as a central processing unit or an accelerator, configured to execute instructions stored in a memory to implement the functions described for the server. The term “information processing terminal” refers to a user-operated device, such as a mobile terminal, wearable terminal, or general-purpose computing device, that is configured to input and output information, communicate with the server via a network, and present audio or visual content to the user.

The term “user” refers to a human operator who interacts with the information processing terminal to input requests, listen to music data, and perform operations such as playback, evaluation, and sharing.

The term “user request information” refers to information indicating a request from the user regarding music generation, including at least natural-language text or speech-derived text that expresses desired characteristics of music.

The term “attribute information” refers to information indicating characteristics of the user that are independent of a specific session, such as demographic information, preference information, or other profile-related information stored in association with the user. The term “behavior history information” refers to information indicating past behavior of the user in relation to music content, including at least playback history, selection history, evaluation history, or sharing history, and derived features thereof.

The term “emotion state information” refers to information representing a state of emotion of the user at a particular time, such as relaxed, sad, joyful, or excited, and may include discrete labels, continuous values, or probability distributions output by an emotion recognition process.

The term “prompt sentence” refers to a text sequence constructed by the server that encodes conditions or instructions for music generation, and that is input to a generative AI model as a control signal to cause the generative AI model to generate music data satisfying specified requirements.

The term “generative AI model” refers to a trained machine learning model, such as a neural network model, configured to generate music data in response to input including at least a prompt sentence, based on parameters learned from training data.

The term “music data” refers to digital data representing audio content that is perceptible as music to a listener, and includes at least audio waveforms or encoded audio files suitable for playback on an information processing terminal.

The term “storage subsystem” refers to a hardware and software arrangement, including at least one memory device or storage device, configured to store digital information such as music data, prompt sentences, and associated metadata in a retrievable form.

The term “digital format” refers to a representation of information as discrete numerical values suitable for processing, storage, and transmission by digital computing equipment.

The term “user identification information” refers to information that uniquely or pseudo-uniquely identifies a user within the system, such as an identifier assigned by the server.

The term “generation time information” refers to information indicating a time at which music data is generated, such as a timestamp or a time interval.

The term “communication interface” refers to a hardware and software interface configured to send and receive data between the server and the information processing terminal via a communication network.

The term “playback request” refers to information transmitted from the information processing terminal to the server that instructs retrieval and streaming of particular music data for playback.

The term “streaming” refers to a method of transmitting music data from the server to the information processing terminal in a manner that permits the information processing terminal to begin playback before the entire data has been received.

The term “image information” refers to digital data representing visual information acquired from a sensor of the information processing terminal, such as frames captured by a camera. The term “audio information” refers to digital data representing sound acquired from a sensor of the information processing terminal, such as signals captured by a microphone.

The term “emotion recognition process” refers to a computational process executed by an internal module of the server or by an external service that analyzes at least one of image information and audio information and outputs emotion state information indicating a state of emotion of the user.

The term “generation condition” refers to information used as a parameter, constraint, or context in controlling generation of music data by the generative AI model, including at least elements of the prompt sentence and emotion state information.

The term “dynamic control module” refers to a functional module implemented by the processor that is configured to monitor changes in emotion state information, generate updated prompt sentences, invoke the generative AI model with the updated prompt sentences, and control the timing and order of playback of music data segments.

The term “music data segment” refers to a portion of music data corresponding to a temporal section of an audio work, such as a clip or interval that can be individually generated, transmitted, and combined.

The term “crossfade” refers to a transition method between two music data segments in which the amplitude of a first segment is decreased while the amplitude of a second segment is increased in an overlapping time period, thereby achieving a perceptually smooth changeover.

The term “publication instruction information” refers to information input from the information processing terminal that indicates a user's intention to make particular music data accessible to other users via a distribution service or a sharing infrastructure.

The term “distribution service” refers to a computer-implemented service that stores and provides access to music data over a communication network to a plurality of users.

The term “sharing infrastructure” refers to a computer-implemented platform or subsystem that manages identifiers, access control, and delivery of content such as music data for sharing among multiple users.

The term “public identification information” refers to information, such as a public identifier, link, or code, that is assigned to music data and that can be used by another user or another information processing terminal to request access to the music data.

The term “reference information” refers to information indicating a location, address, or resource identifier associated with music data, which can be used by the server or an information processing terminal to retrieve the music data.

The term “distribution results” refers to information indicating how music data has been accessed or delivered, including at least counts of plays, times of access, or geographic distributions of access.

The term “evaluation results” refers to information indicating explicit or implicit assessments of music data by users, including at least ratings, likes, dislikes, or completion rates. The term “behavior history information” in the context of feedback refers to an aggregation of distribution results and evaluation results stored and processed by the server to influence subsequent generation of prompt sentences and music data.

The term “existing artificial intelligence processing apparatus” refers to an information processing apparatus different from the generative AI model that can interact with a user using artificial intelligence techniques, such as a conversational agent, and that outputs natural-language user request information to the server.

The term “natural-language user request information” refers to text data in a human language that expresses the user's desired characteristics, style, or purpose of the music to be generated.

The term “compatible format” refers to a representation of a prompt sentence that satisfies syntactic and semantic requirements of the generative AI model's input interface, enabling the generative AI model to correctly interpret and process the prompt sentence.

The term “music community” refers to a group or network of users who create, listen to, evaluate, and share music data within or across one or more services provided by or connected to the system.

### 1. Overall Configuration

The server executes one or more programs stored in a non-transitory computer-readable medium. The server may run an operating system such as a general-purpose server operating system and an application stack such as a web server (for example, an HTTP server) and an application framework (for example, a Python-based framework). The server connects to a database management system, such as a relational database (for example, MySQL or PostgreSQL), and to an object storage system or file system for storing audio files. The terminal executes a native or web-based client application. The terminal uses an operating system environment such as a mobile operating system or a desktop operating system and provides user interfaces implemented by a graphical toolkit or browser. The terminal accesses hardware devices, including a camera, a microphone, a loudspeaker or headphone jack, and a wireless network interface (for example, Wi-Fi or cellular).

The server and the terminal communicate via a packet-switched network such as the Internet. The server exposes an application programming interface (API) over a secure protocol (for example, HTTPS). The terminal sends and receives messages in a structured format, such as JSON, to interact with the server.

### 2. Server Hardware and Software Configuration

The server includes at least one central processing unit (CPU) and may include at least one accelerator unit, such as a graphics processing unit (GPU) or other parallel processor. The server memory stores runtime data structures including user profiles, feature vectors, prompt sentences, emotion states, and metadata for generated music.

The server software is logically divided into modules, which may be implemented as processes, threads, or libraries:
(1) A communication module that terminates HTTP(S) connections, authenticates requests, and parses and serializes messages.
(2) A profile and behavior module that accesses the database to read and update user attribute information and behavior history information.
(3) An emotion analysis module that interfaces with an internal or external emotion recognition engine and converts raw image and audio information into discrete or continuous emotion state information.
(4) A prompt generation module that constructs and updates a prompt sentence to be supplied to a generative AI model.
(5) A generative AI model interface module that transmits the prompt sentence and auxiliary parameters to a generative AI model and receives music data.
(6) An audio processing module that post-processes generated audio signals (for example, resampling, loudness normalization, encoding).
(7) A storage module that writes audio files to storage and creates and updates metadata in the database.
(8) A streaming module that provides audio streaming to the terminal through mechanisms such as progressive download or segmented streaming.
(9) A publication and sharing module that manages public identification information, reference information, and distribution to other terminals.

### 3. Generative AI Model Structure and Training

The server uses a generative AI model that is implemented, for example, as a neural network configured to output audio waveforms or audio tokens conditioned on a text input. The generative AI model may adopt a sequence model architecture such as a transformer, a diffusion-based model, or a hybrid model.

In one embodiment, the generative AI model is a transformer-based sequence generator. The model includes:
(1) A text encoder configured to convert a prompt sentence into a sequence of token embeddings. The text encoder uses a subword tokenizer to map characters and words into token IDs and then maps token IDs into dense vectors via an embedding layer. The text encoder further applies multi-head self-attention layers and feed-forward layers with residual connections and layer normalization.
(2) A conditioning module configured to incorporate additional conditioning signals, such as desired duration, tempo, or emotion state information, into the embedding space. The conditioning module may implement a projection of scalar or categorical features into vectors and add or concatenate these vectors to the text embeddings.
(3) A decoder configured to output either time-domain audio samples or discrete audio tokens that are subsequently decoded by a separate decoder network or vocoder. The decoder uses causal self-attention layers to maintain autoregressive constraints when generating audio sequences. The decoder may generate a sequence of latent codes which are then converted to waveforms by a neural vocoder such as a convolutional or autoregressive waveform synthesizer.

The generative AI model is trained in advance on a large corpus of music and corresponding textual descriptions. The training process uses supervised learning with an objective function such as a cross-entropy loss over token sequences (for discrete audio tokens) or a mean squared error loss between generated and target waveforms, possibly combined with perceptual losses.

The server stores trained model parameters in memory or in a model storage area. The server loads the model into a GPU or similar accelerator for inference. For each inference, the server passes tokenized prompt sentences and conditioning features into the model and obtains generated audio outputs.

### 4. Emotion Recognition Processing

The terminal captures frames from the camera and audio samples from the microphone under user consent. The terminal either:
(1) Transmits raw or compressed video and audio data to the server; or
(2) Preprocesses the data to extract basic features such as face bounding boxes or short-time spectral features and transmits those features.

The server emotion analysis module sends an emotion recognition request to an internal model or to an external emotion recognition service. The service uses, for example:
(1) A convolutional neural network or transformer-based network for facial expression recognition. The network takes as input a tensor representing the face image and outputs scores corresponding to several emotion classes, such as happiness, sadness, anger, surprise, fear, disgust, and neutral.
(2) A recurrent or transformer-based network for speech emotion recognition. The network takes as input acoustic features extracted from the audio (for example, mel-frequency cepstral coefficients, pitch contour, energy) and outputs scores over similar emotion classes. The server normalizes the outputs and selects an emotion label with maximum probability, or computes continuous measures such as valence and arousal by applying a linear or nonlinear mapping to intermediate features. The server then encodes the emotion as emotion state information, for example, “relaxed,” “sad,” “joyful,” or “highly excited.” The server may map low arousal and positive valence to “relaxed,” high arousal and positive valence to “highly excited,” low arousal and negative valence to “sad,” and so on.

The server stores this emotion state information in association with a user identifier and time. The server exposes the emotion state information to the prompt generation module and the dynamic control module.

### 5. Prompt Generation and Update

The server prompt generation module maintains, for each user, a structured representation of factors relevant to music generation, including:
(1) user_request: text representing the last request issued by the user;
(2) user_attributes: profile parameters such as age group, region, typical preferred genre;
(3) behavior_features: derived metrics from behavior history, such as frequency of listening at certain times, distribution of preferred tempo, proportion of tracks liked or skipped;
(4) emotion_state: current and recent emotion labels and values.

The server prompt generation module applies a set of deterministic rules or a learned transformer-based text planner to construct a prompt sentence. In an embodiment based on deterministic rules, the module uses templates such as:
“Generate a [duration]-minute [genre] track for a [age group] user in [region] who usually listens to [typical context] music and is currently feeling [emotion_state]. Use [preferred instruments] and tempo [tempo_range] BPM. The music should match the request: ‘[user_request]’.”

The module selects “genre,” “typical context,” “preferred instruments,” and “tempo_range” by a mapping from behavior_features. For example, if a user frequently listens to low-tempo jazz tracks with plano and drums, the server sets genre to “relaxing jazz,” typical context to “cafe background,” preferred instruments to “soft plano and light drums,” and tempo_range to “80 to 90 BPM.”

In an alternative embodiment, the server uses a smaller text generation model (for example, a lightweight transformer) trained to map a structured feature vector into a natural-language prompt sentence. The server encodes user_attributes, behavior_features, and emotion_state as a serialized feature string and feeds it to the text generation model. The text generation model outputs a prompt sentence, which the server post-processes to ensure it meets syntactic and semantic constraints required by the generative AI model.

The server stores the prompt sentence in the database for debugging, auditing, and future model improvements.

Examples of prompt sentences include:
“Generate a 3-minute relaxing jazz track for a 25-year-old woman in Tokyo who usually listens to cafe background music and is currently feeling relaxed. Use soft plano and light drums and tempo 80 to 90 BPM. The music should match the request: ‘I want music that is perfect for cafe time.’”
“Generate a 2-minute dramatic orchestral track matching a user who is joyful and highly excited during a movie climax. Emphasize powerful percussion, fast tempo 130 to 150 BPM, and rising string motifs.”
“Generate a 4-minute slow, gentle plano and strings piece for a user who is feeling sad and calm. Focus on a comforting, hopeful atmosphere, low tempo 50 to 60 BPM, suitable for quiet reflection.”
“Generate a 3-minute upbeat pop track for a 20-year-old user in Japan who likes energetic dance music and wants to share it on social media. Include a catchy hook and tempo 120 to 130 BPM.”

By explicitly encoding attribute information, behavior history information, and emotion state information into the prompt sentence, the server causes the generative AI model to utilize a richer condition set than human operators could feasibly handle manually in real time, thereby improving personalization and relevance.

### 6. Music Generation and Audio Processing

The server generative AI model interface module receives the prompt sentence and additional numerical parameters such as target duration, sampling rate, and output format. The module converts the text into a sequence of token IDs using a tokenizer compatible with the generative AI model. The module also encodes numeric conditioning features, such as desired duration and tempo, into continuous vectors. These vectors are appended to or combined with the text embeddings output by the text encoder.

The server then calls an inference function on the generative AI model using GPU resources. The model computes a sequence of intermediate hidden states per time step using multiple attention and feed-forward layers. The decoder uses autoregressive sampling or diffusion-based sampling to generate an audio representation. In an autoregressive configuration, the model generates one audio token at a time, using a probability distribution over the token space and sampling or selecting the most probable token at each step. In a diffusion configuration, the model iteratively denoises a latent representation of a sequence of length equal to the target audio length.

The server audio processing module decodes the model output into raw audio samples if necessary. The module applies signal processing algorithms to ensure consistent quality:
(1) Resampling: The module resamples the audio to a standard sampling rate (for example, 44.1 kHz) using a polyphase filter or other resampling technique.
(2) Loudness normalization: The module computes integrated loudness according to a standard, such as ITU-R BS.1770, and adjusts gain so that the track matches a target loudness range (for example, −14 LUFS), reducing the need for per-track manual volume adjustment and providing consistent perceived volume across generated tracks.
(3) Encoding: The module encodes the audio into an appropriate format, such as 16-bit PCM WAV or a compressed format (for example, MP3 or AAC) using a coding library or external executable such as a generic audio encoder derived from open standards.
(4) Trimming and padding: The module cuts leading or trailing silence and pads if necessary to reach the requested duration.

The server stores the processed audio file into storage. The server writes metadata into the database, including user_id, prompt_sentence, emotion_state, creation_time, file_path, duration, and optionally derived audio features such as tempo, key, or spectral centroid.

### 7. Streaming and Playback at the Terminal

The terminal displays generated tracks in a graphical user interface. The terminal uses metadata obtained from the server to list tracks with titles, generation times, and optional emotion tags. The terminal uses a media player component to play music. The terminal requests streaming from the server by providing a track identifier. The server streaming module serves the audio via an endpoint. The terminal begins playback when it has received sufficient data to initiate decoding.

The terminal plays the audio through hardware components such as a digital-to-analog converter and speaker or connected headphones. The terminal sends playback-related telemetry to the server, including events such as play, pause, stop, completion, like, or dislike. The server updates the behavior history information accordingly.

The server uses playback and evaluation history as inputs to behavior_features, which influence subsequent prompt generation. This closed-loop process enables the server to adjust musical characteristics over time in a way that would be infeasible with static “one-shot” prompt design.

### 8. Dynamic Real-Time Adaptation Based on Emotion

The server dynamic control module monitors updated emotion state information from the emotion analysis module. When the user's emotion changes (for example, from relaxed to highly excited), the server generates a new prompt sentence that reflects the updated state, while maintaining continuity with previous content. For example, the server may generate: “Generate a new 30-second section that transitions from relaxed to highly excited for a user whose excitement is increasing during a movie climax. Maintain soft plano from the previous section, gradually add stronger drums, and increase tempo from 80 BPM to 120 BPM.”

The server requests the generative AI model to generate a shorter segment of music data under this prompt, with a start condition that takes into account the ending of the previous segment (for example, by encoding the last bars of the previous audio or its latent representation as additional context). The generative AI model outputs a segment that is harmonically and rhythmically compatible with the previous material.

The terminal receives the next segment in advance of the end of the current segment. The terminal crossfades between them, using overlapping windows and volume ramps computed by the dynamic control module or by the terminal. By preparing the next segment before the transition, the system avoids dropouts and maintains real-time responsiveness while reducing the need to send complete new tracks.

This dynamic adaptation improves technical performance by:
(1) Reducing network load because the server generates and transmits only incremental segments rather than entire duplicate tracks when emotion changes in short intervals.
(2) Reducing latency from emotion change to audible change, because the generative AI model processes shorter inputs conditioned on previously generated context.
(3) Improving resource utilization on the server side by batching short-segment generation across users on shared accelerator hardware.

### 9. Publication, Sharing, and Feedback into Behavior History

The user instructs the terminal to publish particular generated music. The terminal sends publication instruction information to the server. The server publication and sharing module marks the corresponding track as public, assigns or generates public identification information or reference information (for example, a short identifier or URL path), and stores it.

The server associates the public identification information with access control metadata. When another user's terminal accesses the identifier, the server authenticates the request as needed and streams the corresponding audio.

The server tracks the number of accesses, geographic regions of access, and evaluation events (for example, likes and comments) from other users. The server aggregates these events and stores them as distribution results and evaluation results. The server transforms these into behavior history information for the originating user and for the community. For example, the server may track that a certain style of generated track tends to receive more positive evaluations when associated with certain emotion conditions.

The prompt generation module uses this community-level behavior history to adjust rule parameters or feature weights for future prompt sentences. For example, if tracks described as “relaxing jazz” with tempo 80 to 90 BPM and plano focus receive consistently high evaluation for similar emotion states, the server may prioritize such configurations for new users with similar attributes and emotion states. This adaptive modification of prompt design constitutes a specific computer-implemented strategy to improve the accuracy and utility of generative AI-driven music generation over time.

### 10. Technical Effects and Improvement of Computer Technology

The server achieves several technical improvements beyond mere automation of human creative tasks.

First, the server uses a structured and programmatic integration of multiple heterogeneous input signals user request information, attribute information, behavior history information, and emotion state information to construct prompt sentences. This reduces trial-and-error prompt design by human operators and enables the generative AI model to receive consistently formatted, information-rich inputs. As a result, the server reduces the number of inference attempts needed to reach acceptable outputs, thereby decreasing compute time and improving throughput.

Second, the server implements a dynamic control module that generates shorter incremental music segments and orchestrates crossfaded playback rather than repeatedly regenerating entire tracks on every emotion change. This control strategy reduces the amount of data transmitted over the network and reduces computation time on the generative AI model by restricting generation to segments. Thus, the server improves communication efficiency and processing speed in a way that depends on and improves the operation of computer hardware.

Third, the server stores prompt sentences, emotion states, and distribution and evaluation results in structured database schemas and uses them to compute behavior_features that iteratively refine future prompts. This improves the accuracy and stability of the generative process over time. The adaptive feedback loop constitutes a particular data management and algorithmic scheme that improves computer decision-making (for example, model conditioning and resource allocation) rather than merely reflecting user preference tracking. Fourth, the server uses explicit numerical conditioning for tempo, duration, and emotion-related parameters. By passing structured numeric features into the generative AI model conditioning module, the server reduces variance in the generated outputs and increases controllability. The improved controllability directly translates into lower error rates when targeting desired acoustic properties, and thus less wasted compute on unsuitable outputs. Fifth, the emotion analysis and dynamic control functions permit the server and terminal to coordinate in real time to control internal buffers, crossfade parameters, and streaming windows in a specific manner. The server sends timing information and segment identifiers, and the terminal aligns playback according to this timing. As a result, the system reduces buffer underruns and audible artifacts, thereby improving the technical quality of audio playback compared to conventional, static streaming approaches.

In summary, the server, the terminal, and the generative AI model cooperate under a specific architecture and data flow in which structured feature extraction, prompt sentence generation, controlled generative model invocation, audio signal processing, streaming, and feedback of behavior history are integrated to improve the functioning of the computer system as a whole. The system achieves faster and more accurate generation of context- and emotion-aware music content, more efficient use of computing and communication resources, and more stable and reliable audio playback than conventional systems that treat generative AI as a simple, isolated tool.

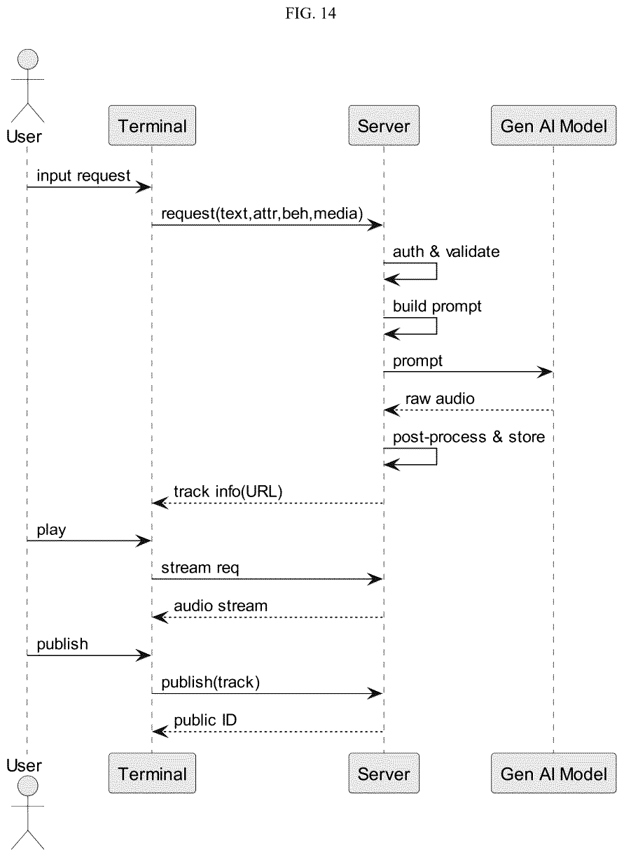

The following describes the processing flow using FIG. 14.

### Step 1

User operates the terminal to input a music request.

User touches a text input area or activates a voice input control on the terminal and provides a natural-language request, such as “I want music that is perfect for cafe time” or “Create music that matches my current mood.” The input of this step is raw user intent in the form of text typed on a keyboard or speech captured by the microphone. The terminal converts speech to text using a speech recognition component, so the output of this step is a text string representing the user request, associated with a user identifier in the terminal's session state.

### Step 2

Terminal collects attribute information and behavior history information.

Terminal reads stored profile data (for example, age group, region, preferred genres) from secure local storage or from a cached copy of server-side data. Terminal also retrieves behavior history information such as recent playback records, liked or disliked tracks, and timestamps of listening sessions. The input of this step is the user identifier obtained in Step 1. The terminal performs data lookup and simple aggregation (such as counting likes by genre, calculating average tempo of listened tracks), and the output is a structured attribute-and-behavior data object that includes demographic attributes and summarized behavior features.

### Step 3

Terminal optionally acquires image information and audio information for emotion analysis. Terminal, after displaying a consent dialog and receiving approval, activates the camera and microphone to capture the user's face and voice for a short interval. The input of this step is the user identifier and a trigger that emotion-aware mode is enabled. The terminal records a sequence of image frames and audio samples, performs basic preprocessing such as resizing images and downsampling audio, and the output is a media payload (or corresponding feature vectors) that characterizes the user's current facial expression and vocal tone.

### Step 4

Terminal transmits collected data to the server.

Terminal assembles the text request, attribute information, behavior history information, and optional media payload into a single request message. The input of this step is the data produced in Steps 1 to 3. The terminal encodes the message into a structured format, attaches authentication information, and sends the message via a secure communication protocol to the server. The output of this step is a network request containing all user-related input data arriving at the server.

### Step 5

Server authenticates and validates the request.

Server receives the network request and verifies authentication tokens against an authorization database or service. The input of this step is the structured message from the terminal. The server checks required fields (user identifier, request text), validates data types and ranges, and discards or sanitizes malformed fields to prevent injection or corruption. The server then logs the request with a unique request identifier. The output of this step is a validated request object stored in memory and associated with a request identifier.

### Step 6

Server retrieves and updates attribute and behavior information.

Server uses the user identifier from the validated request to query the database for persistent profile and behavior records. The input of this step is the user identifier and any attribute or behavior features provided by the terminal. The server merges terminal-supplied summaries with stored records, resolving conflicts by predefined rules (for example, giving precedence to most recent timestamps). The server calculates higher-level behavior features such as preferred tempo range, preferred instrument categories, and typical listening context using aggregation and statistical operations over the behavior history. The output of this step is a comprehensive feature set describing the user's attributes and behavior, stored in a server-side structure.

### Step 7

Server performs emotion recognition and determines emotion state information.

Server reads the media payload or feature vectors sent by the terminal. The input of this step is the image information and audio information associated with the request. The server forwards this information to an emotion recognition process, which applies trained neural networks for facial expression and speech emotion classification to compute probability distributions over emotion categories and optionally valence arousal coordinates. The server then selects a dominant category or derives an emotion label such as “relaxed,” “sad,” “joyful,” or “highly excited” by thresholding and mapping functions. The output of this step is emotion state information stored as a label and associated numeric values in a server-side record linked to the request identifier.

### Step 8

Server constructs a prompt sentence for the generative AI model.

Server collects the user request text, attribute information, behavior features, and emotion state information. The input of this step is the feature set from Step 6, the emotion state from Step 7, and the original user request. The server applies template rules or a prompt-generation algorithm that inserts feature values into sentence patterns, for example selecting a genre based on behavior features and an emotion descriptor based on emotion state. The server combines these into a coherent text such as:
“Generate a 3-minute relaxing jazz track for a 25-year-old woman in Tokyo who usually listens to cafe background music and is currently feeling relaxed. Use soft plano and light drums and tempo 80 to 90 BPM. The music should match the request: ‘I want music that is perfect for cafe time.’”

The data processing in this step includes selection, mapping, and concatenation of strings, as well as numerical-to-text conversion for parameters like tempo and duration. The output of this step is a single prompt sentence stored in memory and in a log associated with the request.

### Step 9

Server encodes the prompt sentence and conditioning features for the generative AI model. Server takes the prompt sentence and additional numeric conditioning signals (such as target duration, target tempo range, and encoded emotion values) as input. The server tokenizes the prompt sentence into token IDs using a tokenizer consistent with the generative AI model. The server also normalizes numeric features and projects them to a vector space through look-up tables or small neural network layers. The data processing here consists of discrete string-to-token mapping, normalization, and vectorization. The output of this step is a set of model-ready inputs: token sequences for the prompt sentence and conditioning vectors for duration, tempo, and emotion.

### Step 10

Server executes inference on the generative AI model to generate music data.

Server feeds the token sequences and conditioning vectors into the generative AI model loaded on a GPU or other accelerator. The input of this step is the model-ready input from Step 9 and the current state of model parameters. The model performs multiple layers of matrix multiplications, non-linear activations, and attention operations to compute hidden representations, and then decodes those into a sequence of audio tokens or waveform samples using autoregressive or diffusion-based sampling. The output of this step is raw generated music data, represented as either audio tokens or a raw waveform buffer.

### Step 11

Server post-processes and encodes the generated audio.

Server passes the raw generated music data to the audio processing module. The input of this step is the raw waveform or token sequence from the generative AI model. If the data is in token form, the server decodes it into waveform samples using a vocoder network, again performing matrix operations on the GPU. The server then resamples the audio to a standard sampling rate, applies loudness normalization by computing integrated loudness metrics and adjusting gain, trims silence, and encodes the samples into a chosen audio format such as WAV or MP3 using a codec library. The data processing converts floating-point sample data into a compressed or PCM-encoded file. The output of this step is a finalized audio file in digital format, with consistent sampling rate and loudness.

### Step 12

Server stores music data and associated metadata.

Server writes the finalized audio file to persistent storage, such as an object store or file system, and records its path or identifier. The input of this step is the finalized audio file and contextual information including user identifier, prompt sentence, emotion state, and generation timestamp. The server inserts or updates a database row in a music table, storing metadata fields and the storage path. The data processing here consists of mapping in-memory data into relational records and committing them via database transactions. The output of this step is a stored music record that can be referenced by a unique track identifier.

### Step 13

Server prepares a response and sends playback information to the terminal.

Server retrieves the newly assigned track identifier and constructs a response message. The input of this step is the database record from Step 12. The server composes a payload containing track identifier, prompt sentence summary, emotion label, and a streaming URL derived from the storage path. The server serializes this payload and sends it over the communication interface back to the terminal. The output of this step is a response message that enables the terminal to access the generated music.

### Step 14

Terminal presents the generated music to the user.

Terminal receives the server response and parses the track identifier, summary, and streaming URL. The input of this step is the response message from Step 13. The terminal updates its user interface to display a new music entry with a play control, description, and optionally an emotion tag. The terminal also configures its media playback component with the streaming URL. The data processing involves parsing structured data and updating UI components. The output of this step is a visible and interactive representation of the generated music on the terminal's display.

### Step 15

User initiates playback and evaluates the music.

User selects the newly generated track on the terminal and activates the play control. The input of this step is the displayed list of tracks and user interaction events. The terminal begins fetching audio data from the streaming URL and feeds it to an audio decoder that converts encoded frames into PCM samples, which are then sent to the audio output hardware. User may also press evaluation controls such as “like,” “dislike,” or provide ratings. The output of this step is the actual playback of music to the user's ears and generation of evaluation events that the terminal records locally.

### Step 16

Terminal sends playback and evaluation events to the server.

Terminal accumulates playback telemetry (such as play start, pauses, completes, skips) and evaluation actions (likes, dislikes) into a batch. The input of this step is the event log generated in real time during playback. The terminal periodically or immediately sends these events to the server as a telemetry request. The data processing at the terminal includes event aggregation and formatting. The output of this step is a telemetry message that reflects the user's behavior during playback.

### Step 17

Server updates behavior history information based on telemetry.

Server receives the telemetry message from the terminal. The input of this step is the event data linked to user and track identifiers. The server parses the events, updates per-track and per-user counters (for example, number of full plays, early skips, like/dislike ratios), and writes updated statistics into behavior history tables. The server may also compute additional derived features such as completion rate or average rating per style. The output of this step is updated behavior history information that will be used in future feature extraction and prompt generation.

### Step 18

Server adapts future prompt generation using updated behavior history.

Server, upon receiving updated behavior history, recalculates behavior features for the user, such as updated preferred genre distribution or adjusted tempo preferences. The input of this step is the updated behavior statistics from Step 17. The server updates the feature vectors used in Step 6 and the mapping rules applied in Step 8. For instance, if the user consistently dislikes high-tempo tracks, the server adjusts the tempo_range that will be inserted into subsequent prompt sentences. The data processing involves statistical updates and parameter adjustments. The output of this step is a modified configuration and feature set that directly changes the content of future prompt sentences.

### Step 19

Server monitors emotion state changes and prepares updated segments.

Server periodically or event-wise receives new emotion recognition results from the terminal. The input of this step is updated emotion state information with timestamps. The server compares the new emotion state with previous states and determines whether a significant change has occurred. If a change is detected, the server constructs a new short prompt sentence designed to create a transitional segment, for example:
“Generate a new 30-second section that transitions from relaxed to highly excited for a user whose excitement is increasing during a movie climax. Maintain soft plano from the previous section, gradually add stronger drums, and increase tempo from 80 BPM to 120 BPM.” The data processing includes temporal comparison, thresholding, and prompt template selection. The output of this step is a transition-oriented prompt sentence and associated numeric parameters ready for submission to the generative AI model.

### Step 20

Server generates and delivers transition segments for seamless playback.

Server processes the transition prompt as in Steps 9 to 11 to generate a shorter music segment. The input of this step is the transition prompt and the latent or explicit description of the previous segment. The server requests the generative AI model to consider the previous segment context so the new segment is harmonically and rhythmically compatible. The server then encodes the new segment and sends its streaming URL and timing information to the terminal before the end of the current segment. The output of this step is one or more additional music segments and scheduling metadata for crossfade.

### Step 21

Terminal crossfades between segments for emotion-following playback.

Terminal receives the URL and timing metadata for the next segment. The input of this step is the current playback position and the segment scheduling data from Step 20. The terminal pre-buffers the next segment, then lowers the volume of the current segment while raising the volume of the new segment over a defined overlap window, calculated from timing parameters. The data processing includes controlling audio mixer gains and synchronizing playback positions. The output of this step is a continuous audio experience in which the musical content follows the user's changing emotion state without abrupt interruptions.

### Step 22

User issues a publication instruction for a selected generated track.

User chooses a track on the terminal and selects an option to publish or share it. The input of this step is the list of generated tracks and user selection events. The terminal displays a form to allow the user to edit a public title or description. The user approves the publication. The output of this step is publication instruction information including the target track identifier and optional public metadata.

### Step 23

Terminal transmits publication instruction information to the server.

Terminal packages the publication instruction into a request message with track identifier, public title, description, and sharing scope. The input of this step is the user's publication decision and metadata. The terminal sends this message to the server via the communication interface. The data processing involves serialization and network transmission. The output of this step is a publication request arriving at the server.

### Step 24

Server registers the track for public access and generates identifiers.

Server receives the publication request, validates the track identifier, and updates the track record to mark it as public. The input of this step is the publication instruction message and the track record from the database. The server generates public identification information, such as a unique public track ID or URL path, and may also register the audio file and metadata in an external distribution service or internal sharing infrastructure. The server writes the public identifier and reference information back into the database. The output of this step is a track configured for access by other users and a public identifier that can be shared.

### Step 25

Server and terminal enable sharing to other users.

Server sends the public identifier and shareable URL to the originating terminal. The input of this step is the updated track record with public information. The terminal receives this data and invokes platform-specific sharing interfaces (for example, a share sheet) so that the user can send the URL to other users via messaging or social services. The output of this step is the distribution of reference information to other terminals belonging to other users.

### Step 26

Server serves public tracks and incorporates community feedback.

Server receives access requests for public tracks from other terminals using the public identifiers. The input of this step is requests from various terminals that include the public identifier. The server authenticates and authorizes access as needed, streams the corresponding music data, and logs access counts and evaluations from these other users. The server then aggregates these logs into distribution results and evaluation results in the database. The output of this step is updated community-level behavior history that can be used by the server to refine models and prompt-generation rules at a global or segment level.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

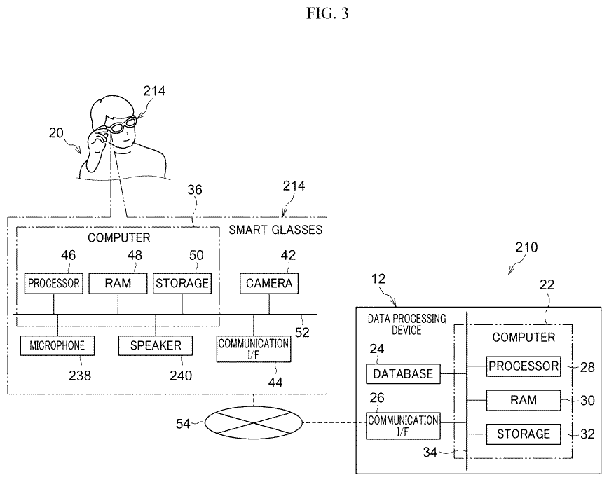

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

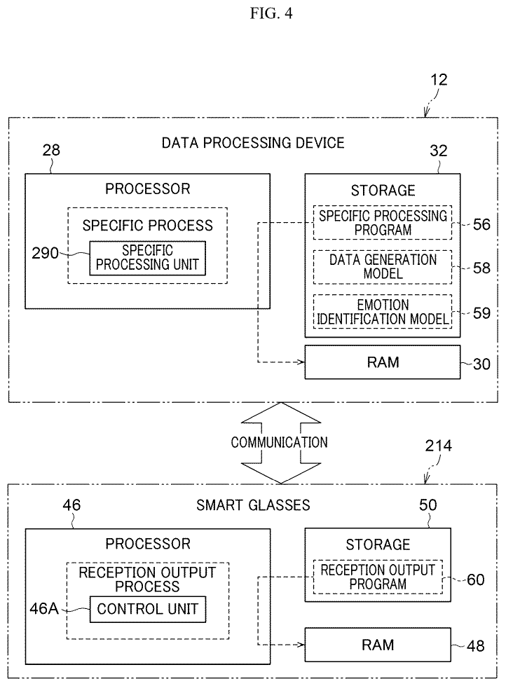

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

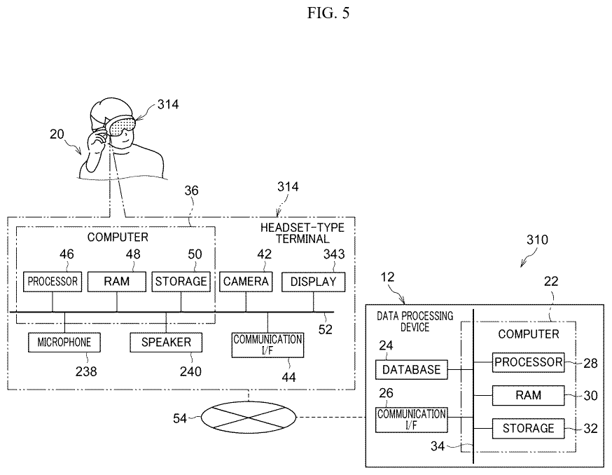

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

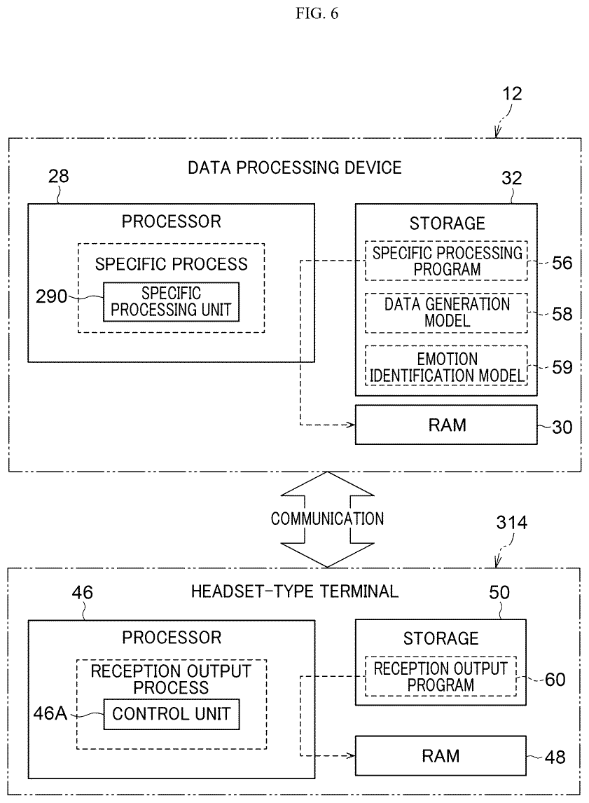

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

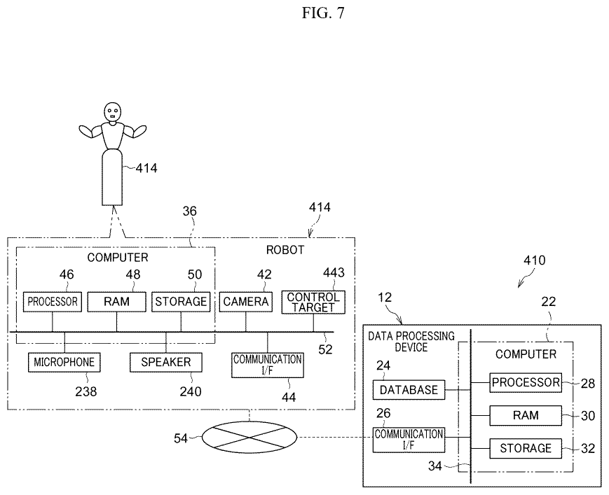

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

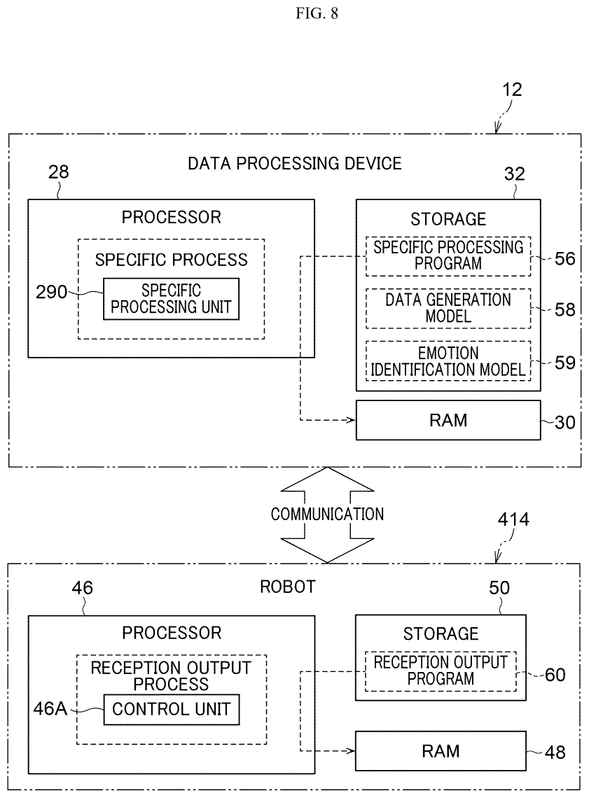

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

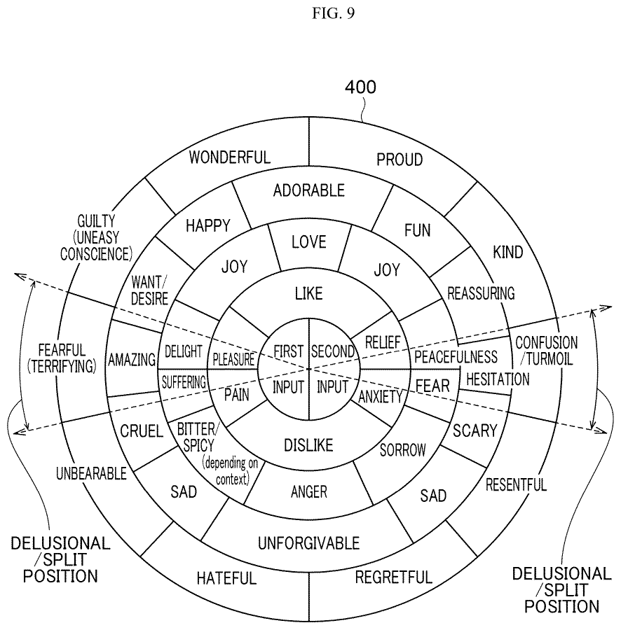

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

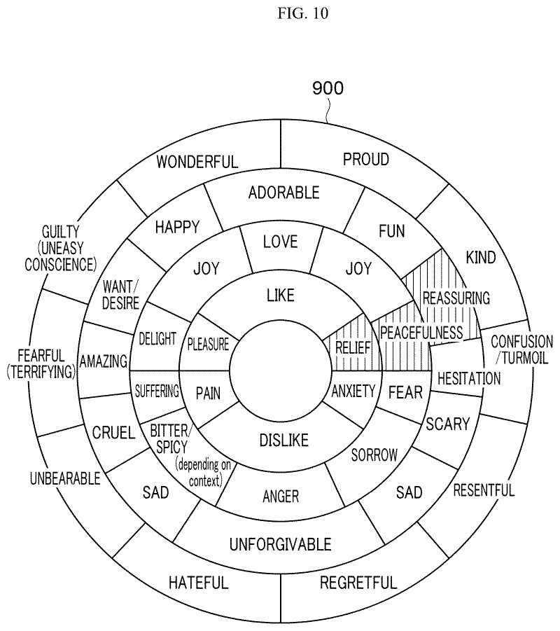

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
obtain, from an input terminal, a request input by a user and attribute information related to the user, and analyze the request and the attribute information as structured information, and generate, based on the analyzed request and the attribute information, model input data including a prompt sentence and numerical feature data to be input to a generative AI model for music generation, and input the model input data to the generative AI model to cause the generative AI model to generate music data, and
convert music data output from the generative AI model into an acoustic waveform, encode the acoustic waveform as an audio file in a predetermined digital format, and store the audio file in a storage device in association with identification information and additional information based on the request and the attribute information, and
receive a playback request from the user for one of the stored audio files, select an audio file corresponding to the playback request, and distribute the selected audio file to the input terminal via a communication network in a streaming format such that the user can play back the audio file at any time, and
obtain a setting related to publication or sharing from the user, and control a publication range of the stored audio file based on the setting so as to enable search and playback of the stored audio file by another user.

### Supplementary 2

The system according to supplementary 1,
wherein the processor is configured to, when the request obtained from the input terminal is speech or text generated by an existing information processing device, perform analysis for generating the prompt sentence in a format compatible with an output format of the existing information processing device, and use an output of the existing information processing device, without modification or with partial conversion, as the prompt sentence to be input to the generative AI model.

### Supplementary 3

The system according to supplementary 1,
wherein the processor is configured to obtain playback history information or evaluation information of the stored audio file from the user and from another user, determine a presentation order or a recommendation result of published audio files based on the playback history information or the evaluation information, and transmit information including the presentation order or the recommendation result to an input terminal of the other user so as to promote use of a sharing platform for the audio files.

### Application Example 1

### Supplementary 1

A system comprising a processor,
wherein the processor is configured to
acquire information indicating a request of a user from an input terminal and analyze the acquired information to extract request contents including music generation conditions,
acquire attribute information and behavioral characteristics relating to the user from a storage device and convert the attribute information and the behavioral characteristics into numerical feature values by performing statistical processing and normalization processing,
acquire detection information from a detection device disposed in an installation space, estimate attributes of customers within the installation space based on the detection information, and generate numerical feature values representing an attribute distribution of a customer group by aggregating the attributes of the customers,
generate, based on the music generation conditions, the numerical feature values relating to the user, and the numerical feature values relating to the customer group, a prompt sentence to be used as input to a generative AI model, the prompt sentence being constructed in a natural language format,
input the prompt sentence and the numerical feature values into the generative AI model and generate music data by numerical computation processing performed by the generative AI model,
encode the generated music data into a predetermined audio data format, store the encoded music data in the storage device, and store, as management information associated with the music data, the prompt sentence and the attribute distribution of the customer group,
monitor the attribute distribution of the customers and an environmental state in the installation space, and, based on a monitoring result, select target music data for playback from the music data stored in the storage device or generate a new prompt sentence and cause the generative AI model to generate additional music data,
distribute the selected or generated music data to an audio output device for real-time playback so as to dynamically optimize an atmosphere of the installation space in accordance with the attribute distribution of the customer group, and
distribute the music data stored in the storage device to a user terminal via a network such that the user is enabled to play back the music data at an arbitrary time.

### Supplementary 2

The system according to supplementary 1,
wherein the processor is configured to generate the prompt sentence by transmitting an intermediate instruction sentence to an external language processing model or an interactive information processing device, receiving, as a response, a natural language sentence from the external language processing model or the interactive information processing device, and adopting the natural language sentence as the prompt sentence to be input to the generative AI model so that the prompt sentence reflects the music generation conditions and the attribute distribution of the customer group in detail.

### Supplementary 3

The system according to supplementary 1,
wherein the processor is configured to perform an information providing process that enables the music data and the management information stored in the storage device to be shared among a plurality of users, analyze requests and attribute information of other users in the information providing process to generate a new prompt sentence, and cause the generative AI model to generate additional music data based on the new prompt sentence, thereby promoting utilization of a music sharing platform and diversification of music selection in the installation space.

### Example 2

### Supplementary 1

A system comprising a processor,
wherein the processor is configured to
receive information transmitted from a terminal operated by a user, the information including a request regarding generation of music, and analyze the information by natural language processing to extract parameters indicating at least one of a type of music, a mood, a tempo, a length, and constituent elements of the music,
generate a prompt sentence to be input to a generative AI model based on the extracted parameters, input the prompt sentence and the parameters as conditioning information to the generative AI model, and generate music data by using the generative AI model,
convert the music data from an internal representation corresponding to an audio signal into digital data in a standardized audio file format, store the digital data in a storage device or an external storage service, and generate identification information or access information that enables streaming or downloading of the digital data in response to a request from the terminal, and transmit the identification information or the access information to the terminal, and
in response to a sharing instruction transmitted from the terminal, register the stored digital data in the standardized audio file format or the access information, via a communication network, in a public area or an information sharing infrastructure so that another user can use the digital data or the access information.

### Supplementary 2

The system according to supplementary 1,
wherein the processor is configured to
receive character information generated by an existing artificial intelligence that acquires a voice request from the user, treat the character information as the request from the user, analyze the character information by the natural language processing to extract the parameters, and automatically input a prompt sentence corresponding to the character information to the generative AI model so as to generate the music data.

### Supplementary 3

The system according to supplementary 1,
wherein the processor is configured to
cause the terminal to provide a user operation screen for transmitting sharing information including the access information to an external information exchange infrastructure or a social communication service, and, based on a transmission of the sharing information, aggregate accesses from other users to the generated music data and promote an increase in utilization of the information sharing infrastructure.

### Application Example 2

### Supplementary 1

A system comprising a processor,
wherein the processor is configured to
acquire user request information and attribute information transmitted from an information processing terminal that receives a request from a user, and analyze the user request information and the attribute information to generate a prompt sentence that instructs a generative AI model to generate music data, and
add, to the prompt sentence, at least one feature based on behavior history information of the user and emotion state information of the user so as to detail the prompt sentence, and input the detailed prompt sentence into the generative AI model to cause the generative AI model to generate the music data, and
store the music data in a digital format in a storage device, and manage the music data in association with user identification information, generation time information, the prompt sentence, and the emotion state information, and
receive, for the stored music data, a playback request from the information processing terminal, and distribute the music data by streaming via a communication line to the information processing terminal so that the user can play back the music data at any time, and acquire image information and audio information from the information processing terminal, estimate the emotion state information of the user based on the image information and the audio information by using an internal or external emotion recognition process, and reflect the estimated emotion state information as a generation condition of at least one of the prompt sentence and the music data, and
sequentially generate a new prompt sentence in accordance with a change of the emotion state information estimated by the emotion recognition process, input the new prompt sentence into the generative AI model to dynamically generate updated music data, and realize real-time music playback that follows the emotion state information by causing the information processing terminal to continuously switch or crossfade between music data segments during playback, and
acquire publication instruction information for the music data from the information processing terminal, register the music data, based on the publication instruction information, in a distribution service or a sharing infrastructure that allows access by other users, and generate public identification information or reference information for the music data, and cause the music data published by the registration to be reproducible and shareable by other users, thereby promoting activation of a music community.

### Supplementary 2

The system according to supplementary 1,
wherein the processor is configured to
integrate natural-language user request information acquired from an existing artificial intelligence processing apparatus with at least a part of the attribute information, the behavior history information, and the emotion state information, and convert the integrated information into the prompt sentence in a format compatible with the generative AI model, thereby enabling generation of the music data while maintaining compatibility with the existing artificial intelligence processing apparatus.

### Supplementary 3

The system according to supplementary 1,
wherein the processor is configured to
distribute, to another information processing terminal used by another user, the public identification information or the reference information corresponding to the music data, and, in response to access from the another information processing terminal, provide the music data via the distribution by streaming, and feed back distribution results and evaluation results of the music data as the behavior history information to a process of generating the prompt sentence, and reflect the behavior history information in subsequent generation of the prompt sentence and the music data.

What is claimed is:

1. A system comprising:
a communication interface coupled to a packet-switched network; and
circuitry configured to:
obtain, from a terminal device via the communication interface, a request input and attribute information related to a user, and analyze the request and the attribute information as structured information;
generate, based on the structured information, model input data comprising a prompt and numerical feature data for a generative neural network model, and input the model input data to the generative neural network model to cause the generative neural network model to generate music data;
convert the music data output from the generative neural network model into an acoustic waveform, encode the acoustic waveform as an audio file in a predetermined digital format, and store the audio file in a storage device in association with identification information and metadata derived from the request and the attribute information;
receive, from the terminal device, a playback request for one of the stored audio files, select an audio file corresponding to the playback request, and distribute the selected audio file to the terminal device via the packet-switched network in a streaming format; and
obtain, from the terminal device, a publication setting from the user, and control a publication range of the stored audio file based on the setting to enable search and playback of the audio file by another terminal device.

2. The system according to claim 1, wherein the circuitry is further configured to extract semantic parameters from the request by executing natural language processing comprising tokenization and intent classification, the semantic parameters comprising at least a genre indicator, a mood indicator, a tempo range, and an instrumentation preference.

3. The system according to claim 2, wherein the numerical feature data comprises generation control vectors derived from the semantic parameters, the control vectors comprising numerical values for tempo, key signature, dynamic range target, and rhythmic pattern specification.

4. The system according to claim 3, wherein the generative neural network model comprises a neural network trained on music audio data, the neural network implementing at least embedding layers, self-attention layers, and waveform synthesis layers that generate time-domain audio samples conditioned on the generation control vectors.

5. The system according to claim 4, wherein the waveform synthesis layers comprise a vocoder module that converts mel-spectrogram representations into time-domain samples at a predetermined sampling rate, and wherein the circuitry applies post-processing comprising peak limiting, dithering, and fade-in and fade-out processing to the audio samples.

6. The system according to claim 5, wherein the encoding comprises selecting a codec from among a plurality of supported codecs based on a quality parameter specified in the request, the supported codecs comprising at least one lossless format and at least one lossy format, and wherein the metadata stored with the audio file comprises codec identifier, bit rate, sampling rate, channel count, and duration.

7. The system according to claim 1, wherein the circuitry is further configured to extract the attribute information comprising a listening history, genre preferences, and mood indicators stored in the storage device in association with a user identifier, and to incorporate the attribute information into the prompt as contextual parameters.

8. The system according to claim 7, wherein the circuitry is further configured to generate a plurality of candidate music data outputs by executing the generative neural network model with different random seed values, rank the candidates based on a compatibility score computed from the attribute information, and select the highest-ranked candidate for encoding and storage.

9. The system according to claim 1, wherein the streaming format comprises adaptive bitrate streaming in which the circuitry segments the audio file into chunks of predetermined duration and transmits the chunks sequentially, adjusting the bitrate based on network condition information received from the terminal device.

10. The system according to claim 9, wherein the circuitry is further configured to maintain a playback session record comprising the user identifier, the audio file identifier, playback start time, playback duration, and completion status, and to store the record in the storage device.

11. The system according to claim 1, wherein the publication setting comprises a visibility parameter specifying at least one of private, shared with specified users, and public, and wherein controlling the publication range comprises updating an access control list associated with the audio file identifier in the storage device.

12. The system according to claim 11, wherein the circuitry is further configured to generate a recommendation list for users based on publication metadata comprising genre labels, mood labels, and popularity metrics, and to transmit the recommendation list to terminal devices via the packet-switched network.

13. The system according to claim 1, wherein the circuitry is further configured to receive feedback information from the terminal device comprising a rating value and descriptive text, store the feedback in the storage device, and adjust generation parameters for subsequent music generation based on aggregated feedback.

14. The system according to claim 13, wherein the adjustment comprises updating preference weights in the attribute information and incorporating the updated weights into subsequent generation control vectors.

15. The system according to claim 1, wherein the circuitry is further configured to receive a request from the terminal device via a voice assistant interface, convert the voice request into text using speech recognition, and use the converted text as the request input for prompt generation.

16. The system according to claim 1, wherein the music data comprises AI-generated musical content, and wherein the metadata comprises a generation timestamp, a model version identifier, and a prompt hash for traceability.

17. The system according to claim 16, wherein the circuitry is further configured to calculate a quality metric for the audio file based on signal-to-noise ratio and spectral balance, and to flag the audio file for regeneration when the quality metric falls below a threshold.

18. A system comprising:
a communication interface coupled to a packet-switched network; and
circuitry configured to:
obtain a request and user attribute information from a terminal device via the communication interface, execute natural language processing to extract semantic parameters comprising genre, mood, tempo range, and instrumentation preference, and generate model input data comprising a prompt and generation control vectors;
input the model input data to a generative neural network model comprising embedding layers, self-attention layers, and waveform synthesis layers to generate music data, convert the music data into an acoustic waveform, and encode the waveform as an audio file using a codec selected based on a quality parameter;
store the audio file in a storage device with identification information and metadata comprising codec identifier, bit rate, sampling rate, duration, genre labels, and a generation timestamp;
receive a playback request from the terminal device, select a corresponding audio file, and distribute the audio file via adaptive bitrate streaming over the packet-switched network;
obtain a publication setting from the terminal device and control a publication range by updating an access control list in the storage device; and
receive feedback information from the terminal device, store the feedback, and adjust generation parameters including preference weights for subsequent music generation.

19. The system according to claim 18, wherein the circuitry is further configured to generate a plurality of candidate outputs using different random seed values, rank the candidates based on compatibility scores derived from the user attribute information, and select the highest-ranked candidate for encoding and storage.

20. A method comprising:
obtaining, by circuitry coupled to a packet-switched network, a request and attribute information from a terminal device, and analyzing the request and the attribute information as structured information;
generating model input data comprising a prompt and numerical feature data based on the structured information, and inputting the model input data to a generative neural network model to generate music data;
converting the music data into an acoustic waveform, encoding the waveform as an audio file in a digital format, and storing the audio file in a storage device with identification information;
receiving a playback request from the terminal device, selecting a corresponding audio file, and distributing the audio file via the packet-switched network in a streaming format; and
obtaining a publication setting and controlling a publication range of the audio file based on the setting.
